(19) United States
(12) Patent Application Publication
(10) Pub. No.: US 2008/0065425 A1
(43) Pub. Date: Mar. 13, 2008

(54) Computer-aided transferring of financial consequences

(76) Inventors: Sandra Giuffre, Wilton, CT (US); Richard H. Nichol, Wilton, CT (US); Sanjay Sathe, Burlington, VT (US); Donald W. Van Dyke II, New Canaan, CT (US)

Correspondence Address: PETER K. TRZYNA, ESQ., P O BOX 7131, CHICAGO, IL, 60680, US

(21) Appl. No.: 11/709,944

(22) Filed: Feb. 21, 2007

Related U.S. Application Data
(60) Provisional application No. 60/775,242, filed on Feb. 21, 2006.

(51) Int. Cl. G06Q 40/00; G06F 17/30; G06Q 50/00; G06F 17/40

(52) U.S. Cl. 705/4; 705/30; 705/7

(57) ABSTRACT

Apparatus (method implemented with a machine, the machine, and the method for making the machine, and products produced thereby, as well as necessary intermediates and storage media). The computer system can, for example, be structured (e.g., including programmed) to carry out at least one of the steps of enabling an exchange of payments between parties related to uncertainty of risk. In another view, computer system can, for example, be structured to aid in at least one of the steps of: entering risk event data, determining, from the risk event data, a projected outcome of a risk event occurring; providing transaction data to specify a transaction in which one party exchanges a fixed payment for another party's variable payment, the fixed payment related to the projected outcome of the risk event occurring, the variable payment related to actual outcome of the risk event having occurred, wherein each party provides a collateral position to ensure an ability to make the payment; periodically computing a mark to market measurement to determine whether one of the parties should make a change to the collateral position to ensure an ability to account for a difference between the actual outcome to the projected outcome, and if the change should be made, to determine an amount of the change.

### I. PRIORITY

This patent application claims priority from, and incorporates by reference, U.S. Patent Application Ser. No. 60/775,242 titled, “COMPUTER-AIDED TRANSFERRING OF FINANCIAL CONSEQUENCES,” filed Feb. 21, 2006.

### II. TECHNICAL FIELD

The technical field is computers and data processing systems. Depending on the implementation, there is apparatus, a method for use and method for making, and corresponding products produced thereby, as well as data structures, computer-readable media tangibly embodying program instructions, manufactures, and necessary intermediates of the foregoing, each pertaining to digital aspects of managing risk.

### III. BRIEF DESCRIPTION OF THE DRAWINGS

FIG. 1 illustrates an overview of an embodiment.

FIG. 2 illustrates an assumption of longevity risk of an embodiment.

FIG. 3 illustrates the mark to market of an embodiment.

FIG. 4—exchange of information of an embodiment.

FIG. 5 illustrates an initial cashflow (initial collateral positions) of an embodiment.

FIG. 6 illustrates a determination of periodic payments of an embodiment.

FIG. 7 illustrates a payment of periodic payments of an embodiment.

FIG. 8 illustrates payments in the event of default of an embodiment.

FIG. 9 illustrates computers of an embodiment.

FIG. 10 illustrates computers of an embodiment.

FIG. 10A illustrates a legend.

FIG. 11 illustrates an embodiment for charitable gift annuities.

FIG. 12 illustrates an embodiment for a reverse mortgage Hedge.

FIG. 13 illustrates an embodiment for a reverse mortgage hedge.

FIG. 14 illustrates an embodiment for a reverse mortgage hedge.

FIG. 15 illustrates an embodiment for a reverse mortgage hedge.

FIG. 16 illustrates an embodiment for a reverse mortgage hedge.

FIG. 17 illustrates an embodiment for a reverse mortgage hedge.

FIG. 18 illustrates an embodiment for a reverse mortgage hedge.

FIG. 19 illustrates an embodiment for a reverse mortgage hedge.

FIG. 20 illustrates an embodiment for a reverse mortgage hedge.

FIG. 21 illustrates an embodiment for a reverse mortgage hedge.

FIG. 22 illustrates an embodiment for a reverse mortgage hedge.

FIG. 23 illustrates an embodiment for a retirement community.

FIG. 24 illustrates an embodiment for a retirement community.

FIG. 25 illustrates an embodiment for a retirement community.

FIG. 26 illustrates an embodiment for a retirement community.

FIG. 27 illustrates an embodiment for a retirement community.

FIG. 28 illustrates an embodiment for a retirement community.

FIG. 29 illustrates an embodiment for a retirement community.

FIG. 30 illustrates an embodiment for a retirement community.

FIG. 31 illustrates an embodiment for a retirement community.

FIG. 32 illustrates an embodiment for a pension.

FIG. 33 illustrates an embodiment for a pension.

FIG. 34 illustrates an embodiment for a pension.

FIG. 35 illustrates an embodiment for a pension.

FIG. 36 illustrates an embodiment for a pension.

FIG. 37 illustrates an embodiment for a pension.

FIG. 38 illustrates an embodiment for a pension.

FIG. 39 illustrates an embodiment for a pension.

FIG. 40 illustrates a securitization transaction of the assembled risk pool of an embodiment.

FIG. 41 illustrates a securitization transaction of the assembled risk pool of an embodiment.

FIG. 42 illustrates a securitization transaction of the assembled risk pool of an embodiment.

FIG. 43 illustrates a securitization transaction of the assembled risk pool of an embodiment.

FIG. 44 illustrates the activities of the risk taker computer.

FIG. 45 illustrates an embodiment for capabilities.

FIG. 46 illustrates an embodiment for commerce.

### IV. MODES

The embodiments and broader principles can be applied to a broad range of Path Dependent risks. To teach the broader aspects herein, a teaching embodiment has a focus on one specific risk—longevity risk, i.e. the risk that an individual or group of individuals live longer than their expected life expectancy. (Life expectancy is the number of years that an individual has a 50% probability of outliving.) However, the issues raised with regard to longevity risk can be applied to all Path Dependent risks such as the risks of disaster, property damage, wind risk, asset value risk, life insurance, interrupted business and operations, disability, casualty, life, meteorological, liability, etc.

By way of an overview, life expectancy is a statistical measure that can be applicable to large pools, but life expectancy has virtually no predictive power when applied to a single individual or small group of individuals. In fact the probability that an individual will live exactly as long as their life expectancy is about 3%. Assuming a somewhat longer life expectancy than is statistically indicated for an individual increases the probability of not having an adverse event. However, it still leaves a very large probability of having an adverse event.

As the number of individuals within a pool increases, the probability that the actual average life expectancy of the pool will match the expected life average life expectancy increases (assuming that pool has been randomly and consistently selected). When that happens the pool is considered to be statistically valid. It may, for example, require a pool size of at least 1000 discrete individuals to have a statistically valid pool.

In many of the products that have life expectancy built into them, investors/suppliers will hit their maximum dollar investment/borrowing limits before they reach a statistically significant pool size, e.g., it may require a dollar investment of $1, billion before a portfolio of reverse mortgages each of which is $1 million reaches a statistically valid size or a retirement community to have 1000 homes. As a result there is a need for a cost effective and efficient life expectancy risk transfer mechanism.

Currently the most prevalent mechanisms for managing this longevity risk are a variants of the same basic structure, i.e., a premium is paid to an insurance company and, in exchange, the insurance company agrees to make a payment for as long as the insured is alive. Variations include tying the payout the performance of an investment portfolio, capping the number of years payments are made, or adjusting forfeiture provisions. This structure is in fact two wrapped into one. The first is an investment product and the second is the probability based on life expectancy that the insurance company will have to make a payment.

All of the variants of the basic theme suffer from three major problems that make these mechanisms an inefficient way of transferring the financial consequences of longevity risk particularly as it relates to non-individuals—entities with small but not statistically valid pools of longevity risk.
1. Because the product may involve an initial payment upfront, only those insurance companies or other risk takers with the highest quality credit standing can be considered. They may or may not (and are frequently not since there is no incentive for them to) be the most competitive in pricing.
2. The “risk less” investment rate that the insurance company or other risk takers can offer on the initial payment will almost certainly be lower than the cost of funds of most institutional entities looking to transfer risk.
3. The initial investment may have to be carried on the balance sheet of the insurance company and may utilize an additional spread beyond the risk-less-investment rate to compensate for the return on equity for the capital set aside and other expenses—such as operating expenses, commissions, premium taxes, etc.

Consider now a means for providing additional cost efficient risk transfer structures to protect investors from the adverse consequences of living longer than expected. Consider that there can be methods and systems for protecting individuals or organizations from the adverse financial consequences, for example, from an individual or pool of individuals living longer than their expected life expectancy. This can be accomplished by, for example, by a method that involves three non-severable or cooperating components.
1. Determining fixed and variable payments (tied to a formula having an outcome that can only be known at some point in the future) that will be exchanged in the future. The corresponding commitments to pay are unrelated to whether an individual or pool survives to a particular date although the magnitude of the variable payment can be effected by the actual outcome.
2. Defining and funding an initial collateral position. Such collateral could comprise cash, bonds stocks, precious metals, art, jewels real estate, or any asset that the parties agree makes acceptable collateral, or credit rating, creditworthiness, etc.
3. Marking to Market, i.e., objectively determining the cost (if any) of replicating the transaction based on the actual (as opposed expected) outcomes in the future.
   Because in the case of a Path Dependent risk the future outcome is a function of past performance, it is possible, utilizing pre-determined formulas, to project the expected future result.

A Path Dependent Risk is a category of risk whose final outcome is a function of what actually occurred in prior periods. Thus, as a transaction unfolds, a new expected final outcome at some point in the future will vary from the final outcome projected at the inception, if between inception and some point in the future the actual outcome has unfolded in a manner different to what was expected. The difference between what was expected at inception to be the final outcome and the new expected final outcome is deemed to be “mark to market” variance.

One way to think about Path Dependent Risk is as a glide path, wherein it is possible to project an expected glide path (e.g., a number of people expected to be alive in an initial pool at various points in the future—such as a ten year period subdivided into one year intervals), and based on an actual outcome (i.e., a number of people within a pool that are actually alive) for part of that period (e.g., three years ) it is possible to project a new glide path for the remaining 7 years. A difference between the initial expected glide path and a new glide path is the mark to market variance.

Some risks, e.g., mortality and longevity, are by their nature Path Dependent while others are completely Path Independent, e.g., because a house was robbed in the in the first six months of a policy period doesn't mean that it couldn't be robbed again in the second six months. However, even Path Independent risks can be structured so as to make them Path Dependent and thereby a suitable application for embodiments herein. Consider one embodiment for auto insurance that can also be applied to disaster, property damage, wind damage, asset damage, interrupted business and operations, disability, criminal act, casualty, life, meteorological, liability, etc. For example, a risk taker enters into a multi-year agreement with a risk seller under which the risk taker either
1. reimburses the risk seller for loses from drivers who make a claim in a specific year but have not made a claim during any of the preceding years of the multi year agreement; or
2. reimburse the risk seller for loses from drivers who have made a claim in a specific year and who have also made claims in each of the prior years.
In each of these cases the Path Independent risk of a bad/good driver has been transformed into a Path Dependent Risk.

One way to think about Path Independent Risk structured to make Path Dependent is as a risk which has an expected outcome and what actually occurs can be evaluated in a context of what was expected to occur.

Path Dependent Risk, and an attendant ability to mark to market, enables an objective determination of the amount of funds a party needs to collateralize its financial obligation associated with the risk transfer transaction. This in turn permits collateralizing the obligation, which in turn enables risk transfer parties to mitigate credit risk (the risk that one party fails to pay the other). Credit risk is sometimes referred to as counterparty risk, creditworthiness, credit rating, etc. Eliminating credit risk can enable:
risk transfer transactions directly between risk sellers and risk takers
a broader scope of potential risk sellers and risk takers and to place risk transfer transactions safely with a transaction party who collateralizes their financial obligation associated with the risk transfer transaction.

Direct transactions by risk sellers and risk takers, and a broader breadth of “creditworthy” collateralized risk transfer transaction parties reduces cost and price associated with transferring risk. Reducing cost and price enables effective risk transfer. The ability to effectively transfer risk enables better capital utilization. Computer-related aspects of such concepts are within the embodiments elaborated herein.

Accordingly, in connection with the embodiments used collectively to teach the broader principles herein, there can be computer support, as in a data processing system, arranged and structured for implementing all or parts of a method to accomplish certain objectives and advance such as efficiency and/or security, and automated variants having controls regarding management of corresponding computer resources.

For example, in one embodiment, there can be a computer based or aided method and system implementation can hedge/protect an interested party (the “risk seller”) against the adverse financial consequences that (for example) an elderly person or pool of individuals to whom the risk seller is obligated to make a payment to for the rest of the pool's life, live longer than their expected life expectancy; by matching the risk seller with a party (the “risk taker”) prepared to financially compensate the risk seller for loss suffered as a result of the pool living longer than expected in exchange for a fee or the benefit derived by the risk seller from the pool not living as long as expected.

In another embodiment, a representative method can comprise determining a target survival date for the pool; establishing a formula for determining the variable payment in the future (in theory sufficient to compensate the risk seller for the financial loss from the pool living longer than expected); determining a fixed payment to be made in the future by the risk seller in exchange for variable payment by the risk taker in the future (the fixed and variable payments are collectively referred to as a “longevity swap”); securing each of parties obligation with an initial collateral position; and periodically marking to market the longevity swap, until an underlying longevity swap contract's maturity. The longevity swap, initial collateral position, and mark to market can be collectively referred to as an Advanced Life Expectancy Risk Transfer Solution (“ALERTS”) method, apparatus, etc. The fixed payment will be based on the expected obligation of making a payment and the variable payment will be based on the actual outcome.

With regard to establishing formulas, in the general case, the formulas can be as follows:

Mark to market formula=originally expected outcome minus reprojected expected outcome;

Initial collateral=statistically based maximum mark to market at next payment date plus statistically expected maximum difference between fixed payment and variable payment on next payment date.

Note that the mark to market is a single value while collateral is a range of value based on the statistical probability.

Such a method can be used by a risk seller, e.g., investors that have invested in products where longevity risk is present and have large but statistically insignificant portfolios, e.g., reverse mortgages, charitable gift annuities, etc. The risk taker who uses such a method can be investors that believe that they can accumulate a large enough portfolio of longevity risk that is statistically significant.

Because, the method, in some embodiments, does not (but conceivably could) require the risk seller to make an upfront payment in exchange for a promise by the risk taker to pay in the future, the credit standing of the risk taker is not as big an issue in some embodiments as it would be in the case of a traditional annuity or variant thereof. Embodiments allow the risk seller to transact with the most aggressive risk taker, e.g., rather than the most credit worthy risk taker who rarely is the most aggressive taker of risk.

Not having to make an up front payment allows the risk seller to keep those funds and invest them in the core business which would earn a higher rate of return than that offered by an insurance company in a traditional annuity structure. This translates into a higher risk adjusted return on equity to the risk seller.

Another advantage for the risk seller is that eliminating the longevity risk eliminates one source of uncertainty thereby allowing for a wider range of investors and lenders in the underlying product, e.g. more people should be willing to invest in reverse mortgages, etc., and/or accept lower rates if they didn't have to deal with the uncertainty of the longevity risk.

Such a method can be used to eliminate credit risk as a consideration both for the risk taker and the risk seller, and/or either for the risk taker or the risk seller. As a result, embodiments can allow transactions between entities besides the traditional insurance companies and financial institutions, e.g. private investors and hedge funds to act as risk takers. These are entities that often have lower cost structures than the insurance industry and financial institutions. This increased capacity can make for a competitive market resulting in lower prices to the risk sellers.

The elimination (or in different embodiments, reduction) of credit risk has the benefit of creating a marketable contract. One party can simply assign its rights to another party. This marketability increases the number of participants in the market.

The mark to market also allows the risk taking investor to put a market value on their investment; many investor are limited to investments that have this feature. Another advantage of having a marketable/transferable contract is that it allows for the disaggregation of the risk taking function into two components—(a) the risk of assembling a statistically valid pool and (b) holding the transaction to maturity and taking the risk of the validity of the actuarial assumption underlying the risk assumptions. This allows two groups of investors to participate rather than just the subset of both groups that is comfortable with taking both risks. This creates an opportunity for a secondary market for a marketable contract.

The structure of the method can be along the lines of a traditional financial product rather than insurance contract, which makes the method more likely to be subject to the same regulations as a financial product rather than an insurance contract. This is a less strict regulatory framework that permits transaction and related participation by institutions that are prohibited from offering insurance products thereby introducing more competition and reducing costs.

In another embodiment, a representative method can use a number of data inputs and actuarial methods that allow a financial institution to establish a price to charge for the longevity risk transfer. The computer-based system and method can take into account the amount of coverage requested, the payment pattern, the life expectancy of the insured, expected investment return on invested assets, expenses, profit and cost of capital charges.

Embodiments can also be understood from the following description when read in connection with the accompanying drawings. It is emphasized that, according to common practice, the various features of the drawing are not to scale. On the contrary, the dimensions of the various features are arbitrarily expanded or reduced for clarity.

The accompanying drawings illustrate embodiments intended to illustrate and exemplify in a teaching manner, by way of the prophetic teachings herein. As used herein, the term “computer” generally refers to hardware or hardware in combination with one or more program(s), such as can be implemented in software. Computer aspects can be implemented on general purpose computers or specialized devices, and can operate electrically, optically, or in any other fashion. A computer as used herein can be viewed as at least one computer having all functionality or as multiple computers with functionality separated to collectively cooperate to bring about the functionality. Logic flow can represent signal processing, such as digital data processing, communication, or as evident from the context hereinafter. Logic flow or “logic means” can be implemented in discrete circuits, programmed computer, or the equivalent. Computer-readable media, as used herein can comprise at least one of a RAM, a ROM, a disk, an ASIC, a PROM, or other storage media. Industrial or technical applicability is indicated herein.

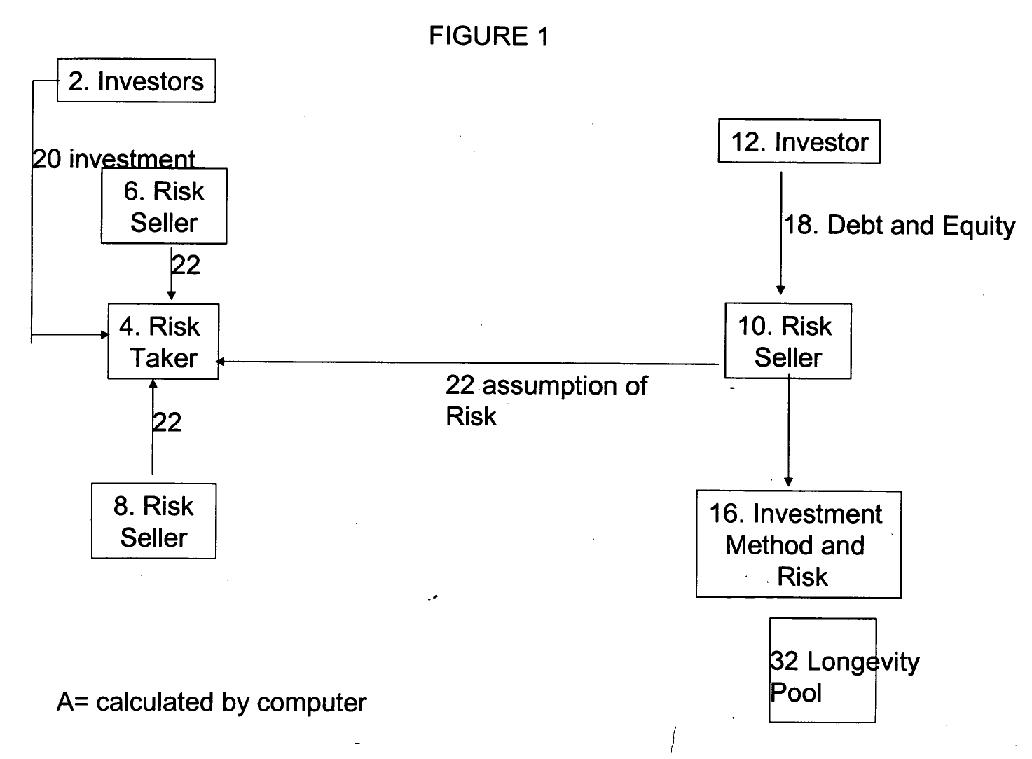

Consider now the figures illustrate so as to teach or illustrate the broader principles at play. The numbering is based on illustrative indicators C=computer action, E=electronic communication, I=data input. It is to be understood that operations are not limited by these indicators and instead that the indicators are for teaching purposes. Thus, for example, in FIG. 1 “A=calculated by a computer” means that this can be one way to utilize a computer, but not the only way.

FIG. 1—Overview

A method for an embodiment can contemplate that one or more investors 2 (such as, but not limited to, a life insurance company, hedge fund, private investor, or other financial institution) invests risk taking capital, i.e., investment 20, into an entity, e.g. one that has the substance if not the form (e.g., segregated accounts or Profit and Loss within an existing entity) of a special purpose entity and that will act as a risk taker 4 to assume the financial consequences of at least one risk or category of risk from one of preferably a plurality of risk sellers 5, 8, and 10. A risk taker 4 among them can assume the financial consequences of one risk category 22 (an assumption of risk) within a segregated account from various risk sellers 6, 8, and 10. For illustrative purposes, there is a limited bur representative number of risk sellers (3) but in practice there could be many; the same holds true for risk sellers). The assumption of risk can be entered into on going basis with different risk sellers by the risk taker 4. For teaching purposes, consider the arrangement as it relates to the assumption of longevity risk of a pool of individuals but the description is applicable to other categories of risk.

These risks are either by their nature Path Dependent or the transaction that incorporates the risk can be structured so as to make the risk Path Dependent. The risk seller 10 could be any kind of entity that has invested in securities, participated in transactions, engaged in a business, assumed obligations acted as a risk taker provided insurance that have risk related to longevity, disaster, etc.

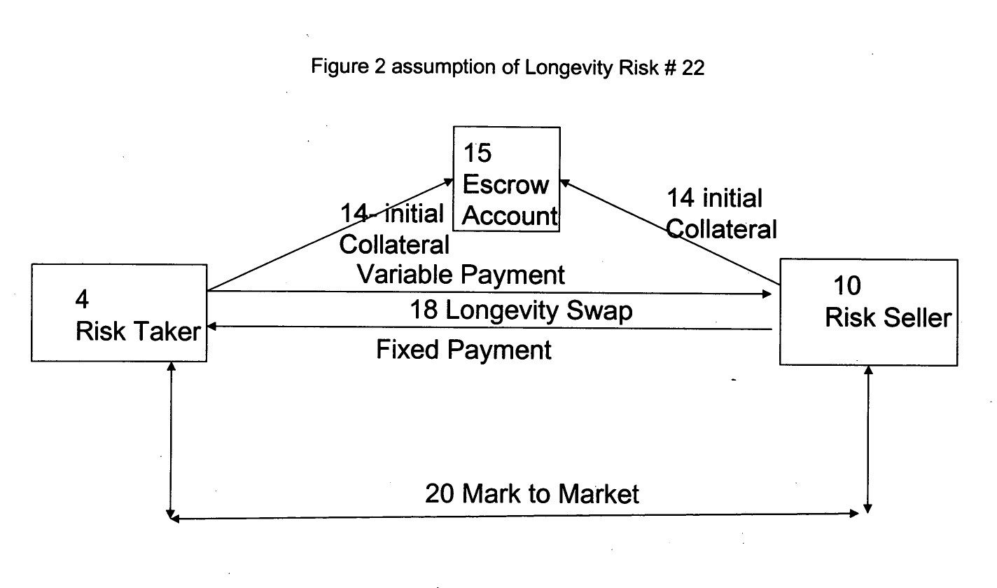

FIG. 2—Assumption of Longevity Risk

The assumption of longevity risk by the risk taker 4 from a risk seller 10 entails the three component transactions that are non-severable or act in cooperation
1. The risk seller 10 will make predetermined fixed payments to the risk taker 4 on specified dates over a period of time (these amounts could be the same for each period or be different amounts but in either case the amount would be predetermined at the inception of the contract);

A. Calculation of Fixed Payment

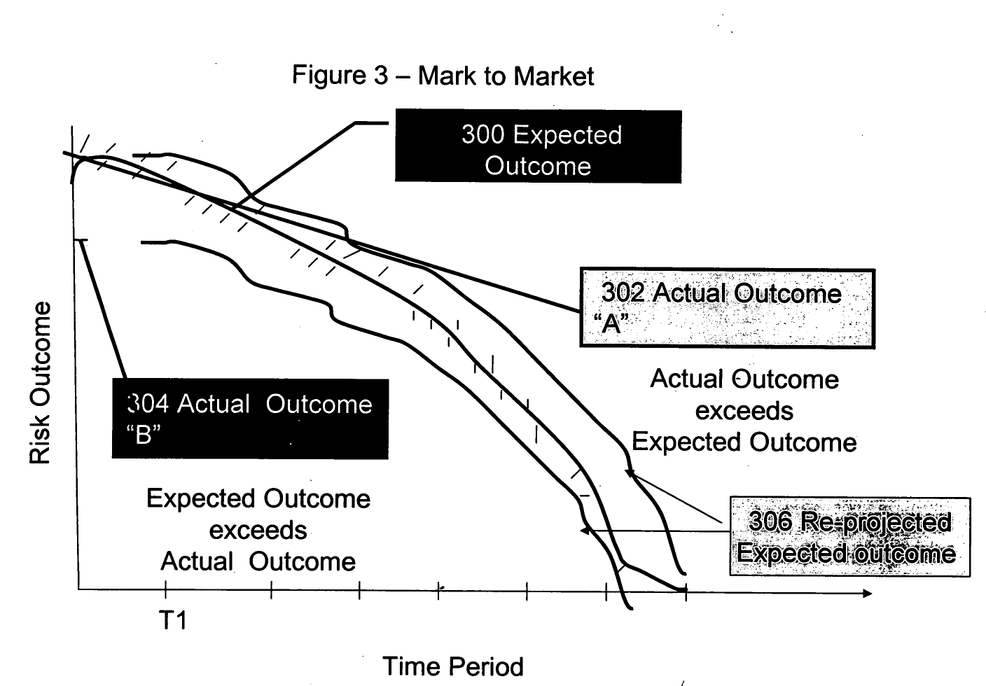

The determination of the fixed payment can be based on two variables—mortality probabilities FIG. 3 I-23 and the financial exposure per individual per year which is determined in advance by the risk seller 10.

Mortality probabilities (C Table 1 below) are the probabilities that an individual belonging to a certain risk class, e.g., blue collar healthy male non smoker will die before their next birthday. For illustrative purposes, RP2000 tables have been used for a healthy 80 year old male—each risk taker 4 will have their own view about which probability tables are the most appropriate measure of risk.

These mortality probabilities are adjusted (reduced) to reflect the return that the risk taker 4 needs to cover their return on equity on the capital employed and expenses to produce the adjusted mortality tables (D table 1 below). The adjusted RP2000 has a 5.95205% % probability of an 80 year old male dying before his 81st birthday or alternatively a 94.04795% probability of living past his 81^{st} birthday. Similarly there are probabilities for an 81 year old, 82 year old etc. It is thus possible to calculate what the probability is of the 80 year old living till his 81^{st}, 82^{nd}, 83^{rd} etc birthday. (Probability of being alive E-table below).

If the risk taker 4 is obligated to pay the risk seller $10,000 on each birthday beginning on the 81^{st} of the currently 80 year old male; based on the probability of the individual being alive it is possible to calculate the probability adjusted expected payment (F-table below) by multiplying the probability by the financial exposure, e.g., 94.04795% multiplied by $10,000 is equal to $9,404.80. Similarly it is possible to calculate the expected amount for the 82^{nd} and subsequent birthday. Because the risk transfer is of a specified period, there is the possibility that individuals within the pool will outlive the term of the risk transfer. Consequently, the final payment will include a pre-multiple (for both the fixed and variable payment) (B table 1 below) to take the extend life expectancy into consideration. The effect of this is to produce a schedule of fixed payments as they relate to the specific individual.

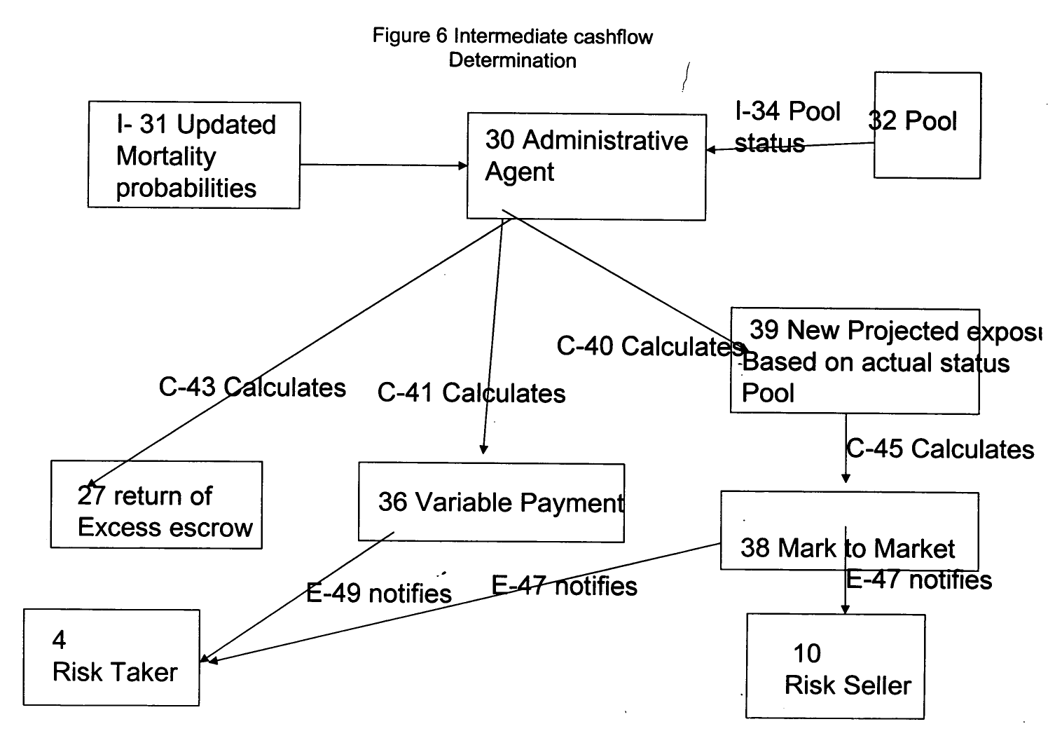

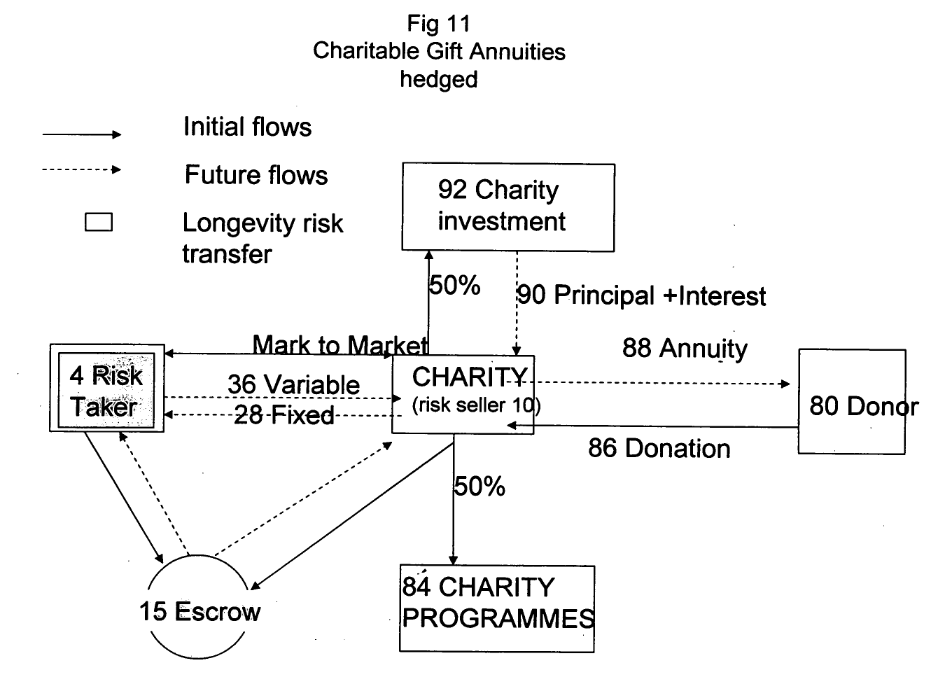

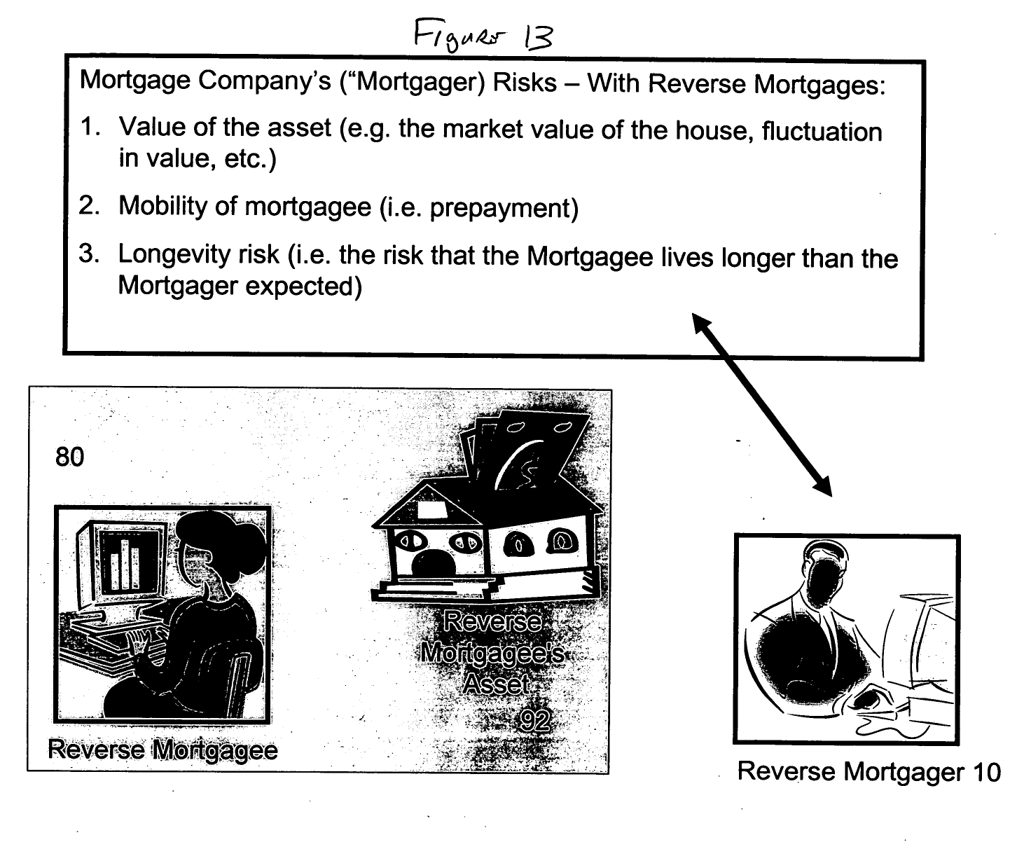

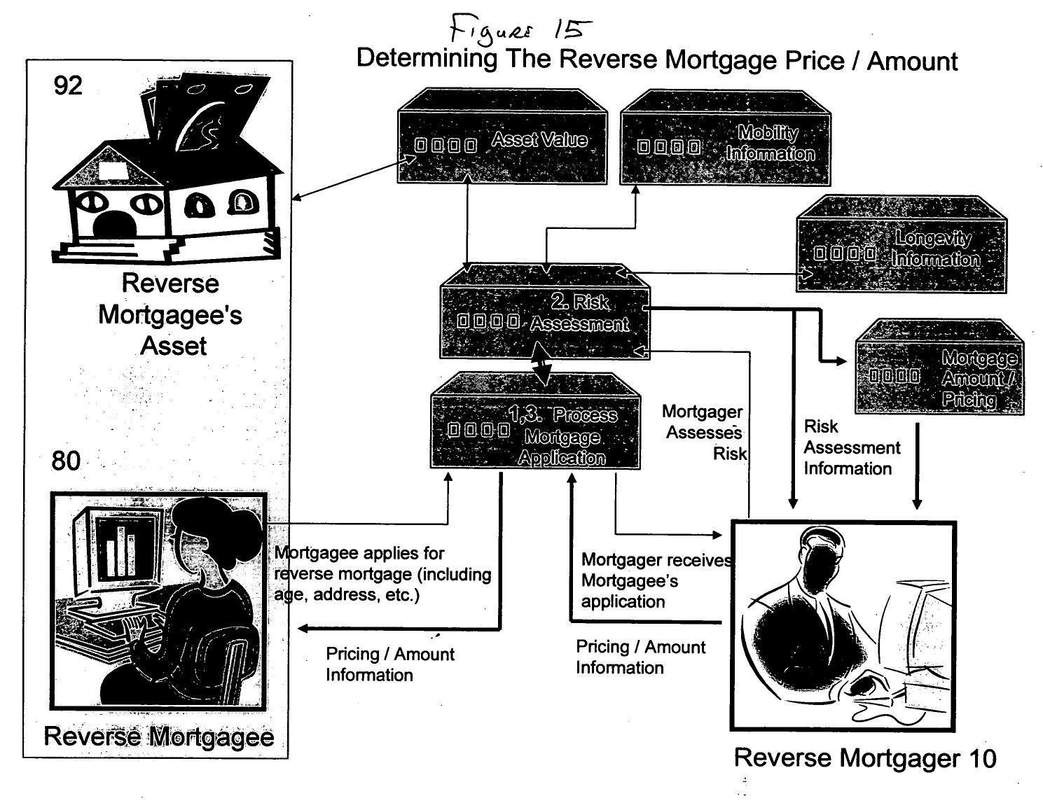

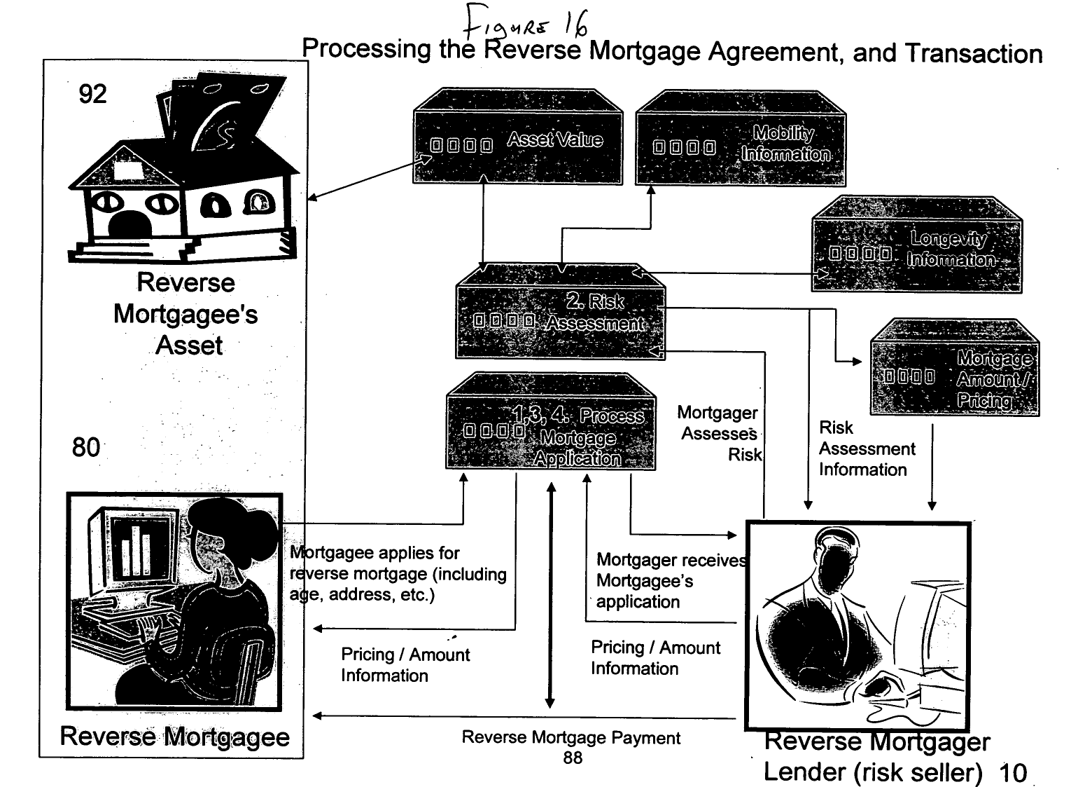

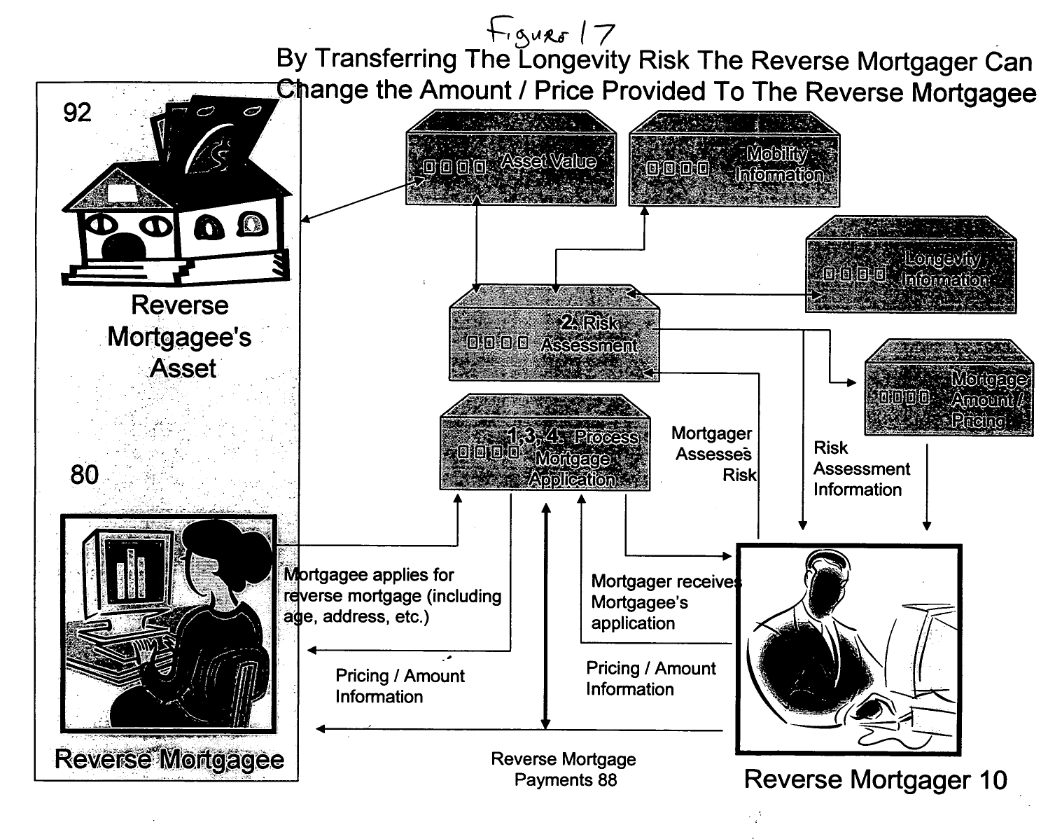

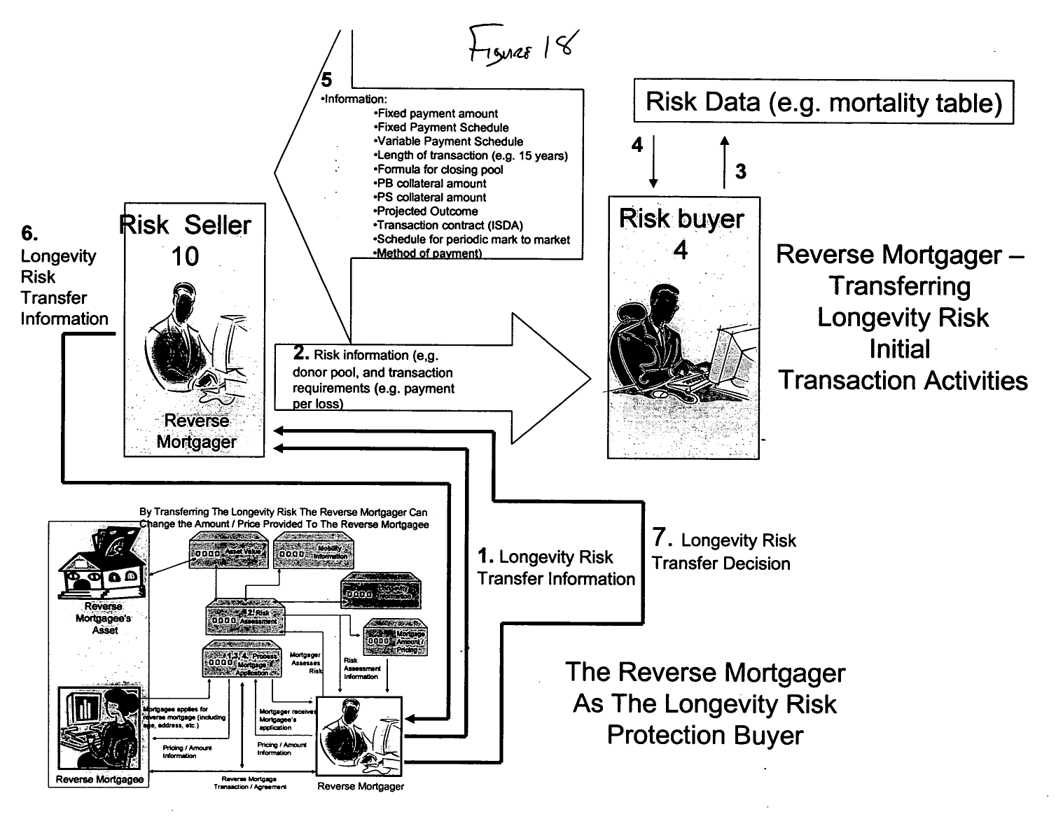

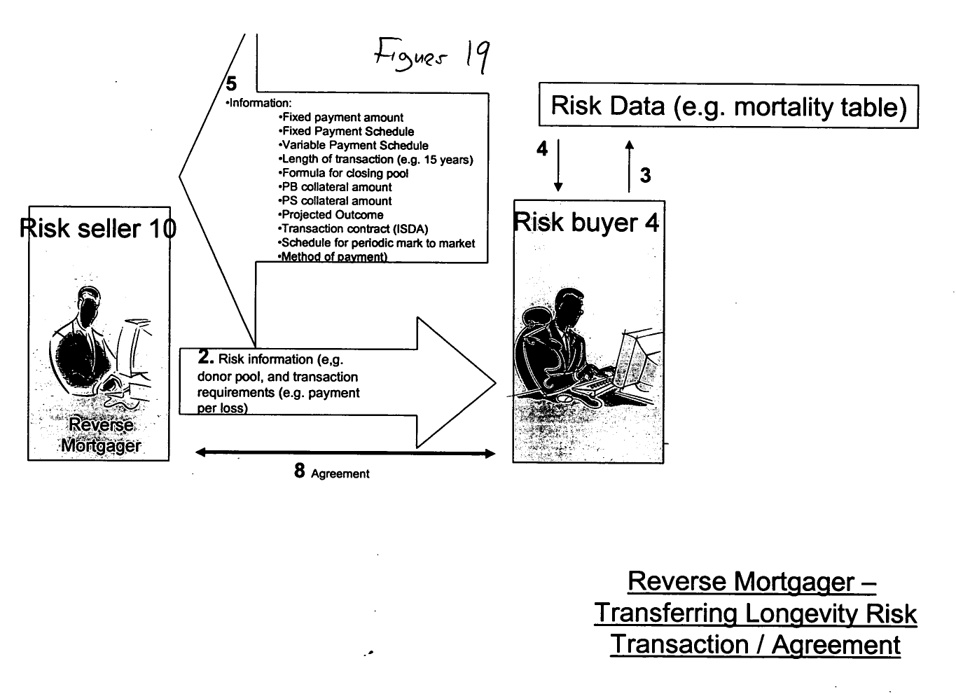

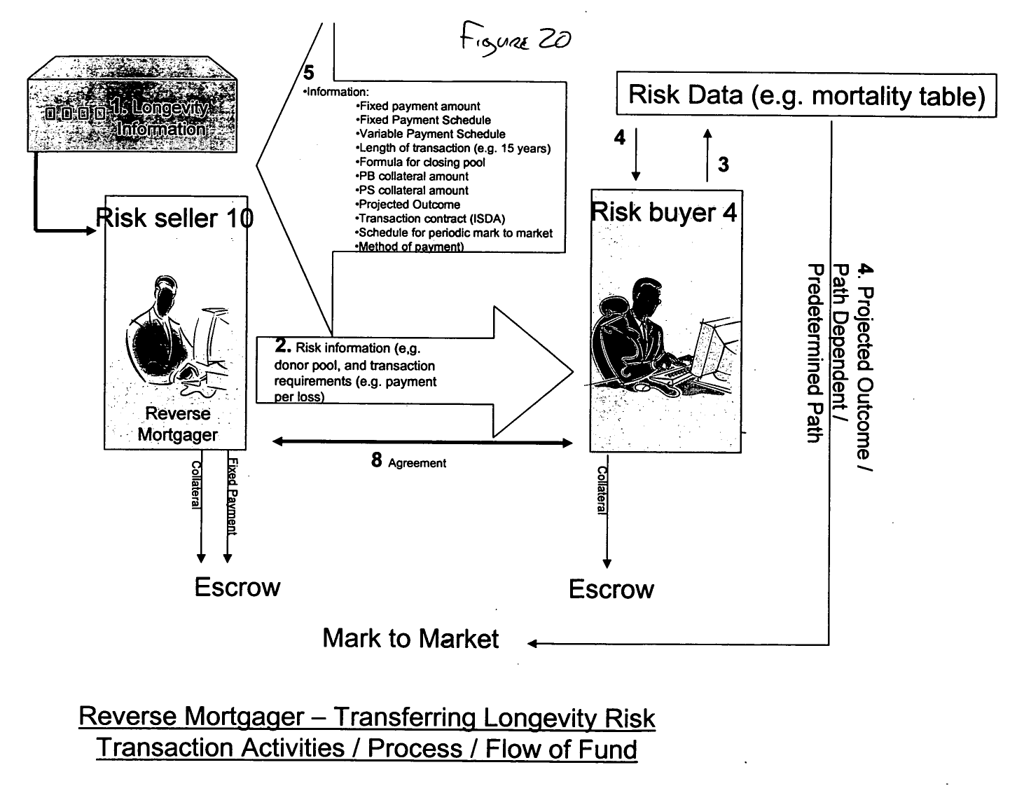

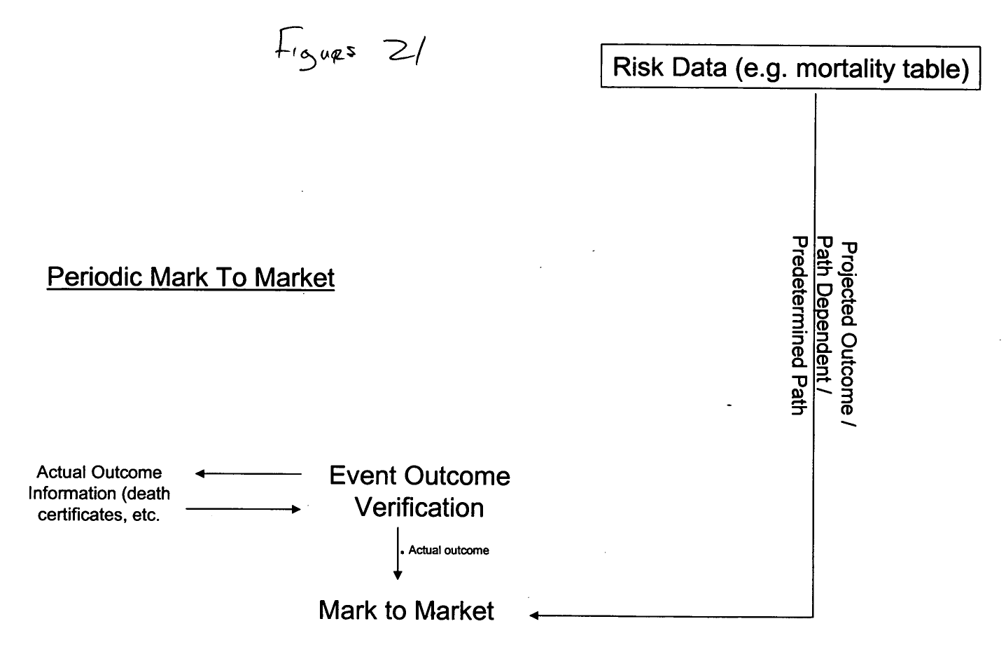

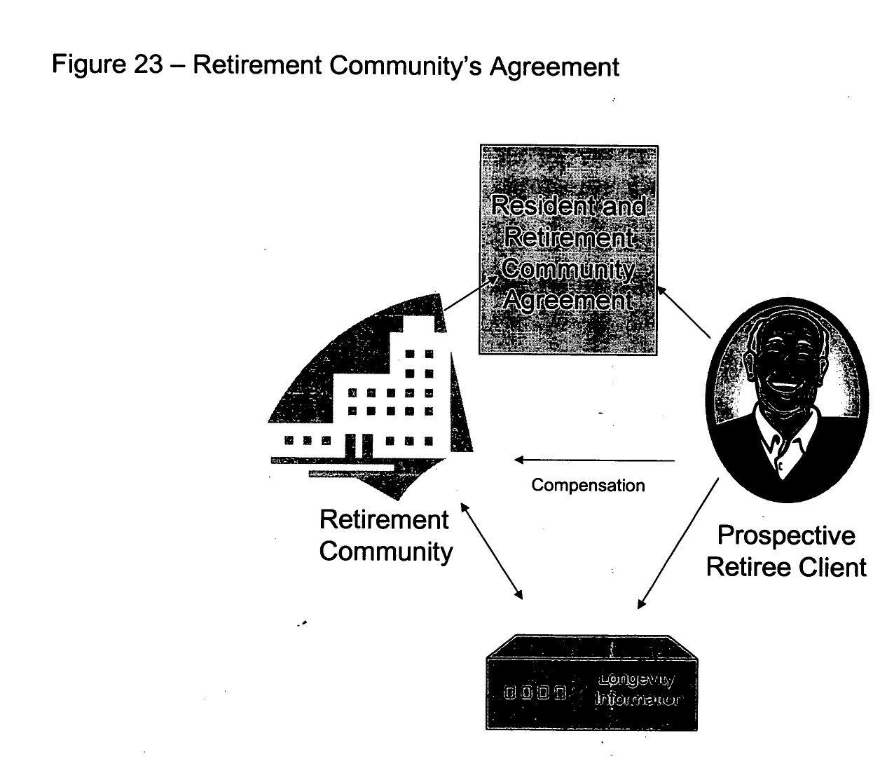

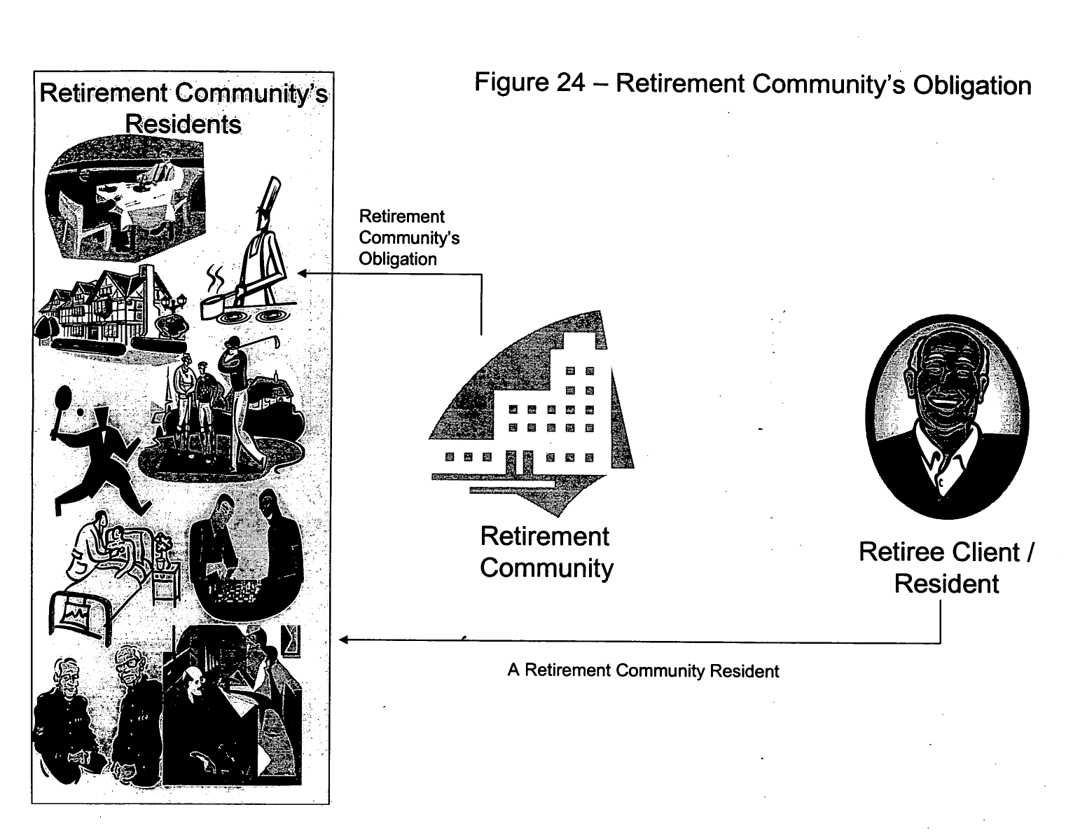

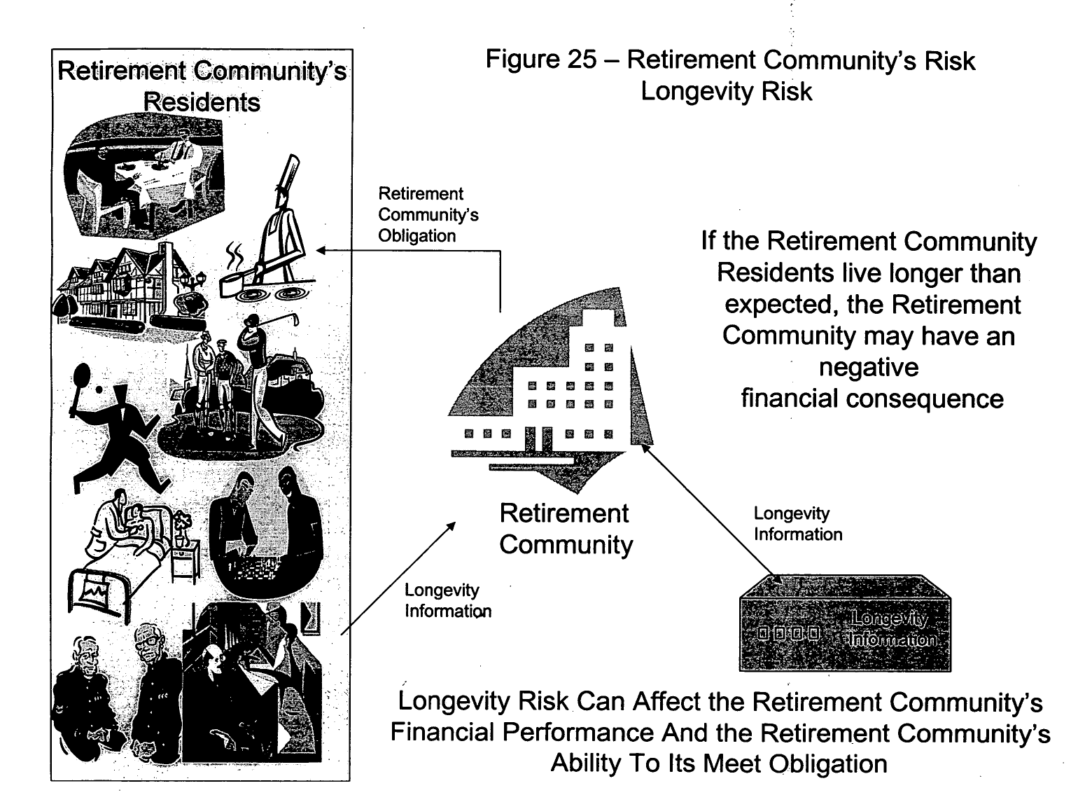

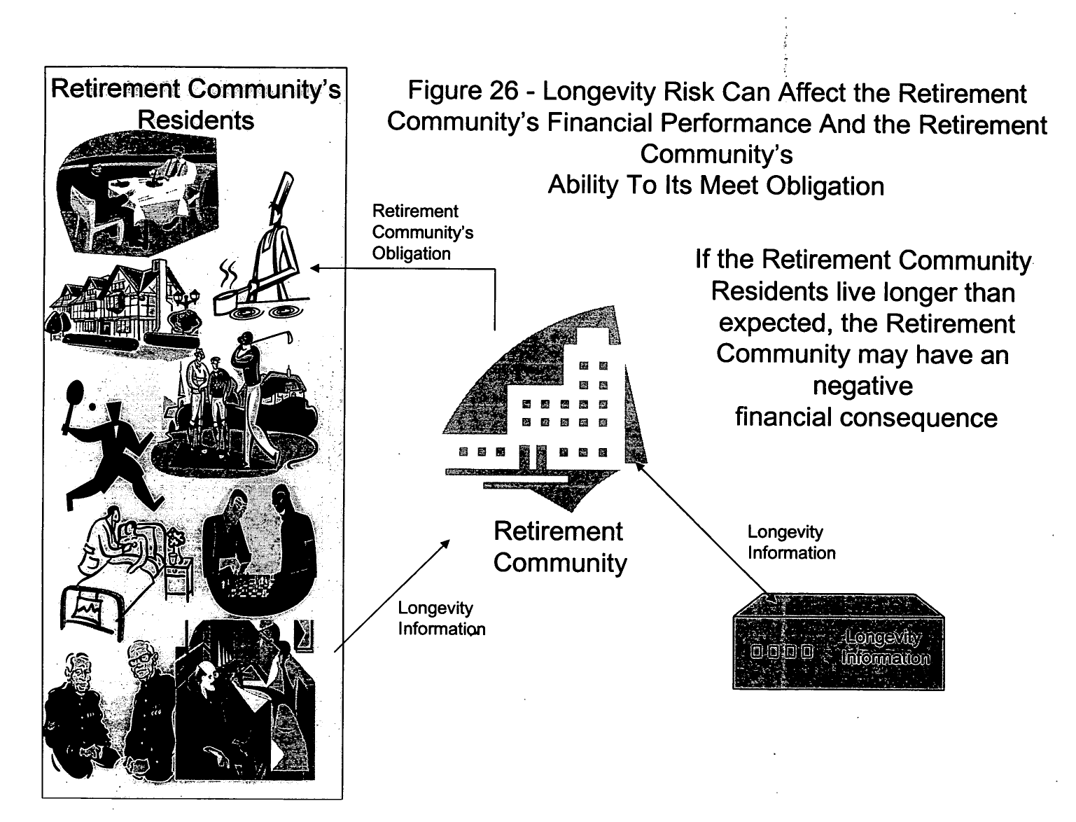

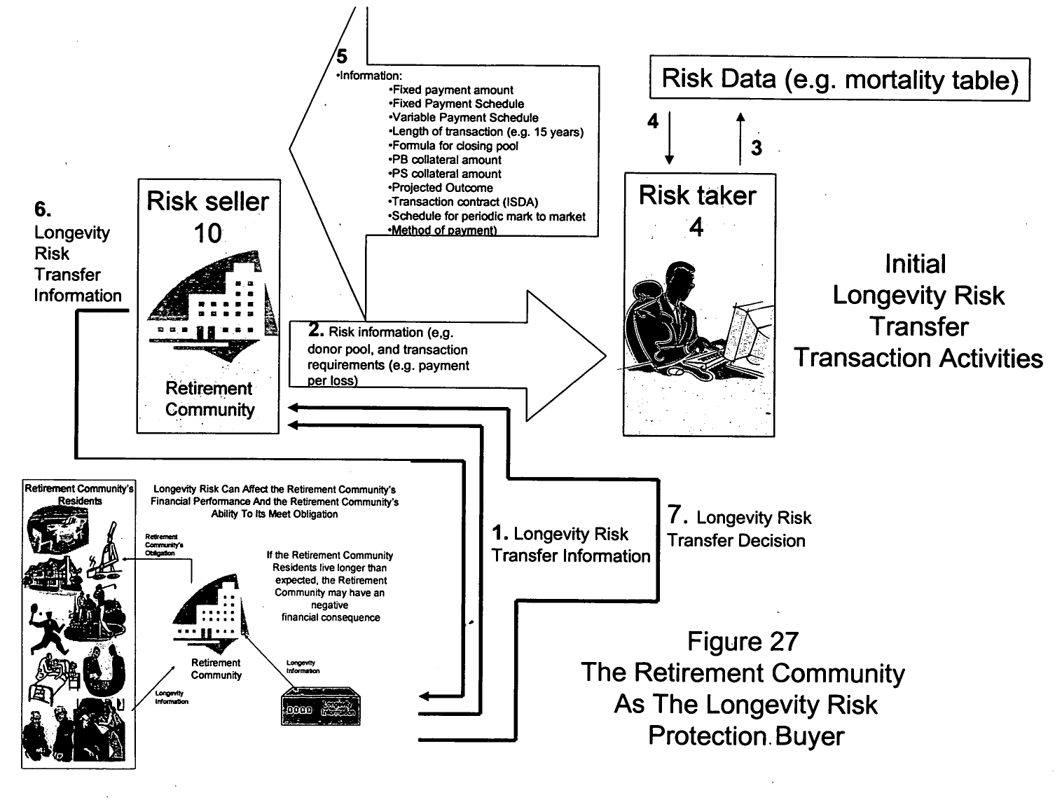

If there is more than one individual in the pool this calculation can be performed before each individual and the amounts aggregated into a single fixed amount. If the payments to individuals within the pool is dispersed over time, a date can be found that is the best fit of all the individual payment dates. The aggregate amount is the fixed amount FIGS. 6-28 that is paid to the risk taker 4 by the risk seller 10.

Note that any table herein is representative of output of a computer system exemplified subsequently. This is especially believed to be true regarding mark to market tables and escrow tables. The effect of the tables is to enable an escrow agent (e.g., permit a bank to act as escrow agent) as the calculations can be done for them and communicated to them. The escrow agent only has to confirm the magnitude of the risk outcome (in the example herein, the number of individuals alive, and read off the table).

A.

TABLE 1
Fixed Payment Calculation
A. FINANCIAL EXPOSURE PER INDIVIDUAL PER YEAR 30000
B. CLOSE OUT MULTIPLE 3.6371527

| | | D. | | | |
|---|---|---|---|---|---|
| | | ADJUSTED | | F. | |
| | C. | MORTALITY | E. | PROBABILITY | G. |
| | MORTALITY | TABLE USED | PROBABILITY | ADJUSTED | PV |
| AGE OF | PROBABILITIES | To INCLUDE | OF BEING | EXPECTED | REMAINING |
| POOL | RP-2000 | ROE/COSTS | ALIVE | PAYMENT | PAYMENTS |
| 80 | 6.4368% | | 100.0000% | | $177,056 |
| 81 | 7.2041% | 5.9520% | 94.0480% | $28,214 | $157,695 |
| 82 | 8.0486% | 6.6498% | 87.7940% | $26,338 | $139,241 |
| 83 | 8.9718% | 7.4125% | 81.2862% | $24,386 | $121,817 |
| 84 | 9.9779% | 8.2438% | 74.5852% | $22,376 | $105,533 |
| 85 | 11.0757% | 9.1508% | 67.7600% | $20,328 | $90,481 |
| 86 | 12.2797% | 10.1455% | 60.8854% | $18,266 | $76,740 |
| 87 | 13.6043% | 11.2399% | 54.0420% | $16,213 | $64,364 |
| 88 | 15.0590% | 12.4418% | 47.3182% | $14,195 | $53,387 |
| 89 | 16.6420% | 13.7497% | 40.8121% | $12,244 | $43,813 |
| 90 | 18.3408% | 15.1532% | 34.6277% | $10,388 | $35,615 |
| 91 | 19.9769% | 16.5050% | 28.9124% | $8,674 | $28,722 |
| 92 | 21.6605% | 17.8960% | 23.7383% | $7,121 | $23,037 |
| 93 | 23.3662% | 19.3052% | 19.1555% | $5,747 | $18,442 |
| 94 | 25.0693% | 20.7123% | 15.1880% | $4,556 | $14,808 |
| 95 | 26.7491% | 22.1002% | 11.8314% | $3,549 | $11,999 |
| 96 | 28.3905% | 23.4563% | 9.0562% | $12,598 | $0 |

B. In exchange for the risk taker 4 making a variable payment on the same dates based on a formula predetermined at the inception of the contract, with both the variable and fixed amounts are collectively referred to as the longevity swap 18. By applying the formula on a payment date the variable amount can be determined. By its nature the variable amount can change on each payment date because the payment is based on what actually occurred (which can change) although the formula will remain predetermined. (As a practical matter the fixed and variable payment can be netted and only the difference can be paid.) The formula used to determine the variable payment can attempt to replicate the adverse financial consequences caused to an investment, transaction, business, security (or the like) risk assumption as a result of an individual or pool of individuals living beyond their expected life expectancy. The person selling the risk can be asked or required to demonstrate that they in fact can suffer financial loss as a result of adverse life expectancy of a specific pool.

C. Calculation of Variable Payment

The calculation of the variable payment is similar to that of the fixed. Except in the case of the variable payment there are only two probabilities 100% (i.e. the individual is alive) or 0% (the individual is not alive). However, this information is only available after the fact and thus the variable payment is a function what actually happened unlike the fixed payment which is based on what is expected to happen.

Table 2 below is an illustration of the variable payment with regard to a hypothetical pool of the 500 eighty year old males. The formula calls for the risk seller to be paid an amount equal to the number of individuals alive multiplied by $30000 (A-table below).

In the first year there are 466 individuals (B-table 2 below). This amount multiplied by $30,000 is the variable payment made to the risk seller (C-table 2 below).

TABLE 2
Calculation of variable payment
Hypothetical pool of 500 individuals
A. FINANCAIL EXPOSURE PER INDIVIDUAL PER YEAR 30000

| | | | | C |
|---|---|---|---|---|
| | | | REMAINING | PAYMENT |
| | | AGE OF | POOL | TO RISK |
| | | POOL | ALIVE | SELLER |
| B | | 80 | 500 | |
| | YEAR 1 | 81 | 466 | $13,980,000 |
| | YEAR 2 | 82 | 431 | $12,930,000 |
| | YEAR 3 | 83 | 395 | $11,850,000 |
| | YEAR 4 | 84 | 359 | $10,770,000 |
| | YEAR 5 | 85 | 322 | $9,660,000 |
| | YEAR 6 | 86 | 285 | $8,550,000 |
| | YEAR 7 | 87 | 249 | $7,470,000 |
| | YEAR 8 | 88 | 214 | $6,420,000 |
| | YEAR 9 | 89 | 181 | $5,430,000 |
| | YEAR 10 | 90 | 150 | $4,500,000 |
| | YEAR 11 | 91 | 122 | $3,660,000 |
| | YEAR 12 | 92 | 97 | $2,910,000 |
| | YEAR 13 | 93 | 76 | $2,280,000 |
| | YEAR 14 | 94 | 58 | $1,740,000 |
| | YEAR 15 | 95 | 44 | $1,320,000 |
| | YEAR 16 | 96 | 32 | $4,451,668 |

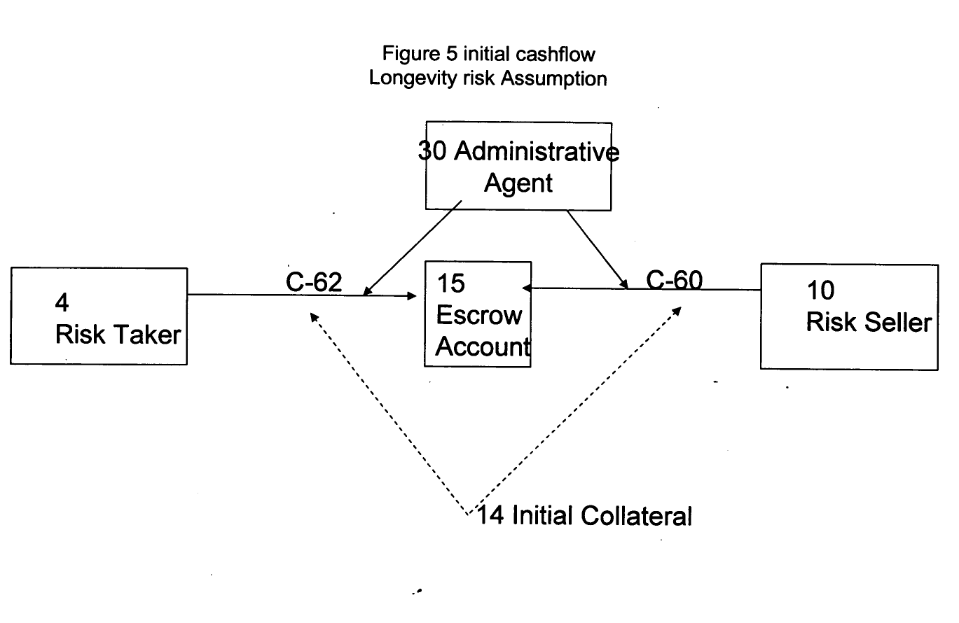

2. Both the risk taker 4 and the risk seller 10 will place in an escrow account(s) 15 as initial collateral position 14 a specified amount of collateral as determined C-60 by the Administrative Agent 30 (FIG. 5) based on the agreement reached between the risk seller 6 and risk taker 4 for the type of collateral that is acceptable.

An objective of the initial collateral is to ensure that there are sufficient funds FIGS. 2-14 placed in escrow FIGS. 2-15 to be able to cover the net difference between fixed and variable FIGS. 2-18 plus the mark to market FIGS. 2-20 that each party might be required to make. Table 3 sets forth an illustrative example of how the initial collateral is calculated with regard to a hypothetical pool of 500 individuals.

In the first year there is a X % probability that the actual number of people alive at the end of the first year will fall in the range between Y and Z. For illustrative purposes assume that the probability is 95% (A-TABLE 3) and the corresponding range is 450-490 (B-Table 3) and the parties have agreed to use these parameters to calculate the initial collateral.

The variable payment that the risk taker 4 will have to make to the risk seller 10 could thus range from a high of $14,700,000 (D-table 3) to a low of $13,500,000 (E-Table 3). If the actual number of individuals within the pool alive at the end of the first year is 450 then the risk seller 10 will have to make a mark to market payment of $3,393,698 (F-table 3) while if the number alive is 490 then the risk taker will have to make a payment of $3,313,296 (G-Table 3). The fixed payment of $14,107,193 (H-Table 3) is unaffected by the number of individuals alive.

Based on these numbers there is the potential (but not the certainty) with a 95% confidence that at the end of the first year the risk seller will have to pay the risk taker up to $4,000,890 (I-Table 3) or that the risk taker will have to pay the risk seller up to $2,706,103 (J-Table 3). These are the amounts that the risk taker and the risk seller will respectively have to place in an escrow account.

TABLE 3
Initial Collateral calculation
Hypothetical pool of 500 individuals

| | | | |
|---|---|---|---|
| A | Confidence interval Probability | 95% | |
| B | 1st Year range | 450 | 490 |
| C | Payment per individual | $30,000 | |
| D | Maximum variable payment | $14,700,000 | |
| E | Minimum variable year 1 payment | $13,500,000 | |
| F | Maximum M to M paid by risk seller | $3,393,698 | |
| G | Maximum M to M paid by risk taker | $3,313,296 | |
| H | First year Fixed payment | $14,107,193 | |
| I | Max risk seller exposure | $4,000,890 | |
| J | Max risk taker exposure | $2,706,103 | |

3. Both the risk seller 10 and risk taker 4 will agree to make periodically to one another “Mark to Market” payments 20 as determined by an Administrative Agent 30 based on the actual mortality experience of the pool up until that point. This discussed in greater detail in FIG. 3 below

FIG. 3—Mark to Market Calculation
At the inception of the risk transfer there is an expected outcome 300 over the life of the risk transfer. At time T1 there are three possibilities. The actual outcome is greater than 302, less than 304 or equal to the expected outcome. Based on this actual outcome in time period T1 it is possible to re-project a future expected outcome 306. The difference between the original expectation and the re-projected expectation is the mark to market.

Table 4 is based on a hypothetical pool of 500 eighty year old males (the transfer has a term of 16 years but we have only shown the first 5 years. The Variable formula is based on the risk seller receiving $30,000 for each individual alive on their 81st and subsequent birthday.

The original present value (A-table 4) of $78,847,373 is the present value for a single individual Table 1-G multiplied by the number of people in the pool; this is the present value of what the risk taker expected to pay to the risk seller after the first year

At the end of the first year (81^{st} birthday) the risk taker 22 had expected that there would be 470.24 individuals still alive—the probability that one individual would be alive Table 1-E of 94.0480% multiplied by 500 (the number of people within the pool). However, in the example the actual number of people alive at the end of the first year is 466 Table 4-E.

Assuming that the mortality probabilities haven't changed (if they had the new mortality probabilities would be used) it is possible to reforecast the number of people expected to be alive in Year 2 and subsequent periods Table 4-F. Applying the same process used in Table 1 it is possible to calculate what the PV of re-forecasted expected payments Table 4-B of $78,136,473 by the risk taker will be. The difference between $78,847,373 and this re-forecasted amount of the $710,910 Table 4-C is the mark to market payment owed by the risk seller to the risk taker at the end of the first year Table 4-D.

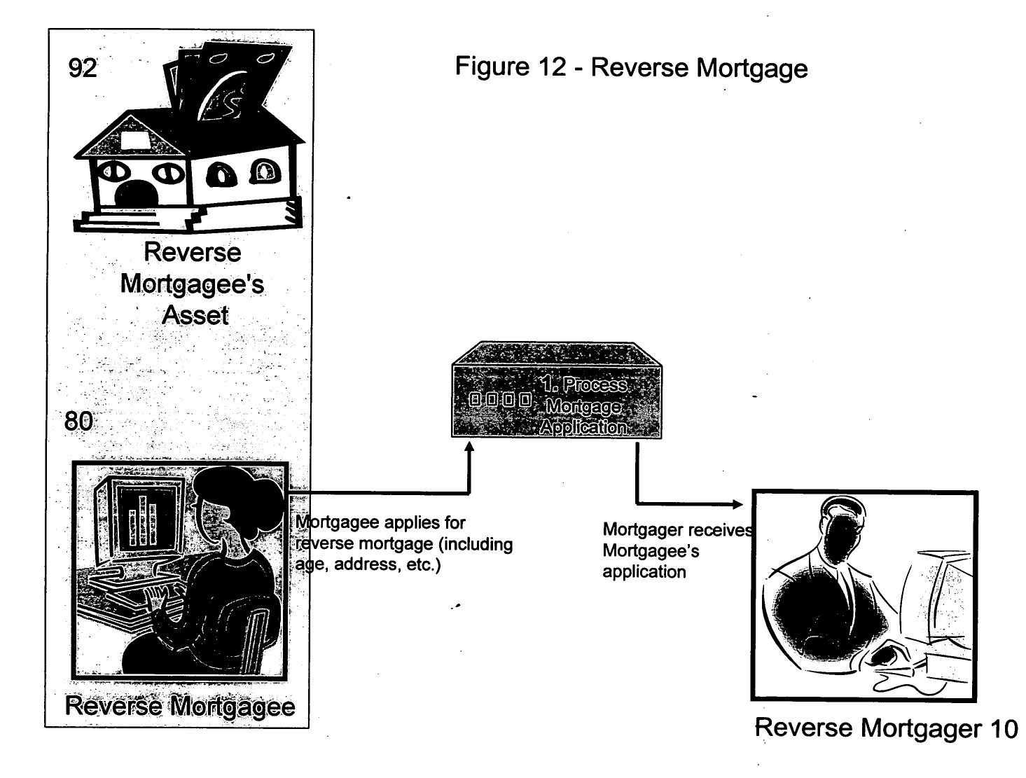

The above calculation is repeated for subsequent periods, e.g., in the second year the difference Table-C is $1,264,020. Of this amount $710,900 was paid in the first period therefore at the end of the second year the risk seller owes the risk taker the difference of $553,120 FIG. 13-D.

Over the life of the transaction, if the parties honor their fixed and variable payments, the net mark to market payment made by the parties to one another will be zero. In the particular example the early year payments made by the risk seller to the risk taker will be repaid to the risk seller by the risk taker in the latter years.

TABLE 4
Periodic Mark to Market
Hypothetical Pool of 500 individuals

| | | | Year 1 | year 2 | Year 3 | Year 4 | Year 5 |
|---|---|---|---|---|---|---|---|
| A | ORIGINAL PV | | $78,847,373 | $69,620,646 | $60,908,746 | $52,766,407 | $45,240,721 |
| B | REFORECASTED PV | | $78,136,473 | $68,356,626 | $59,195,654 | $50,795,997 | $42,997,350 |
| C | DIFFERENCE IN PV | | $710,900 | $1,264,020 | $1,713,091 | $1,970,410 | $2,243,371 |
| D | PERIOD PAYMENT | | $710,900 | $553,120 | $449,071 | $257,319 | $272,961 |
| E | actual | | 466 | 431 | 395 | 359 | 322 |
| F | REFORECAST | YEAR 2 | 435.012037 | | | | |
| | REFORECAST | YEAR 3 | 402.766648 | 399.052004 | | | |
| | REFORECAST | YEAR 4 | 369.563488 | 366.155071 | 362.437105 | | |
| | REFORECAST | YEAR 5 | 335.745559 | 332.649039 | 329.271295 | 326.148712 | |
| | REFORECAST | YEAR 6 | 301.682409 | 298.900047 | 295.864994 | 293.059213 | 289.33141 |
| | REFORECAST | YEAR 7 | 267.773568 | 265.303941 | 262.610024 | 260.119611 | 256.810809 |
| | REFORECAST | YEAR 8 | 234.45774 | 232.295379 | 229.936634 | 227.756073 | 224.858945 |
| | REFORECAST | YEAR 9 | 202.220574 | 200.35553 | 198.321105 | 196.440364 | 193.941582 |
| | REFORECAST | YEAR 10 | 171.577637 | 169.995208 | 168.269064 | 166.673315 | 164.553179 |
| | REFORECAST | YEAR 11 | 143.258792 | 141.937542 | 140.496297 | 139.163927 | 137.393719 |
| | | YEAR 12 | 117.621241 | 116.536442 | 115.353122 | 114.259192 | 112.80578 |
| | | YEAR 13 | 94.9141964 | 94.03882 | 93.0839428 | 92.2011985 | 91.0283708 |
| | | YEAR 14 | 75.255254 | 74.5611885 | 73.8040886 | 73.1041812 | 72.1742735 |
| | | YEAR 15 | 58.6237024 | 58.0830266 | 57.4932472 | 56.9480207 | 56.2236243 |
| | | YEAR 16 | 208.081814 | 206.162713 | 204.069322 | 202.134068 | 199.562861 |

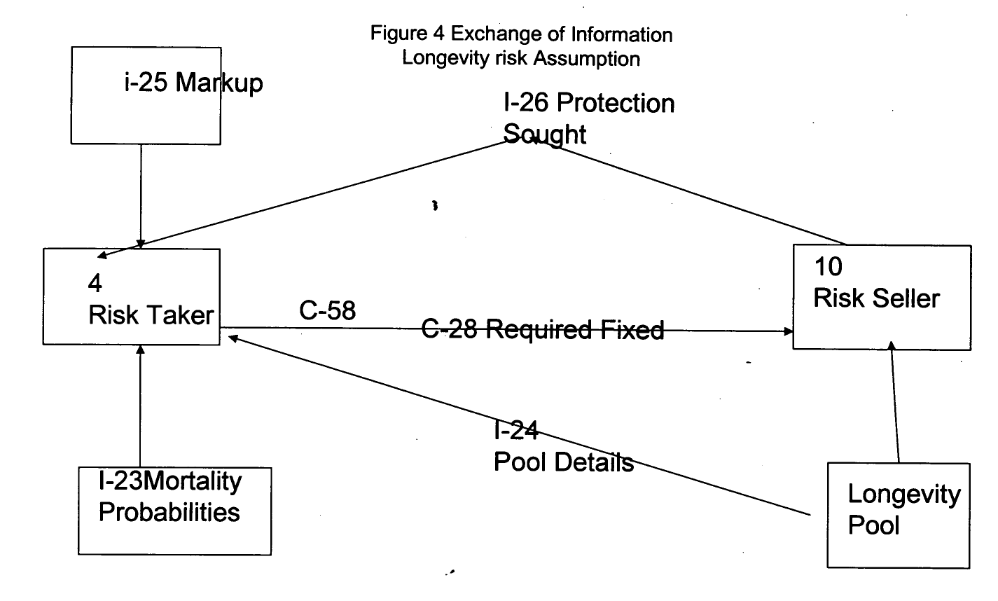

FIG. 4—Exchange of Information

In order to allow the risk taker 4 to assume the longevity risk the risk seller 6 can furnish to the risk taker 4 electronically, or in written form details, 24 on the individuals (age, sex, medical history genealogical information underlying transaction) within the pool whose longevity risk is being assumed by the risk taker; and the level of protection being sought, the basis and starting ages, as captured by the formula used to determine payments in future years based on the actual outcome 26. With this information the risk taker 4 is able to calculate C-58 its potential exposure based on the risk taker's 4 estimation of the life expectancy of individuals within the risk seller's pool. This amount plus a profit is what the risk taker 4 would expect to receive as fixed payment 28 from the risk seller 6. Because each risk sellers 6, 8, and 10 pools will vary so to will be the fixed payments received from each said risk seller 6, 8, and 10.

FIG. 5—Initial Cashflow (Initial Collateral Position)

The initial collateral position 14 is placed in escrow 15 by both the risk taker 4 and risk seller 6, 8, or 10 will be an amount calculated C-60, C-62 by computer by the administrative agent 30 equal to the sum of
a) the difference between the fixed and variable payments in the longevity swap 18 (FIG. 2); and
b) the mark to market payment 20 (FIG. 2).
   Both amounts can be based on (for example) on a 95% statistical confidence interval, i.e., in 95% (or such other confidence interval as the risk taker 4 and risk seller 6, 8, or 10 agree to).

FIG. 6—Determination of Periodic Payments

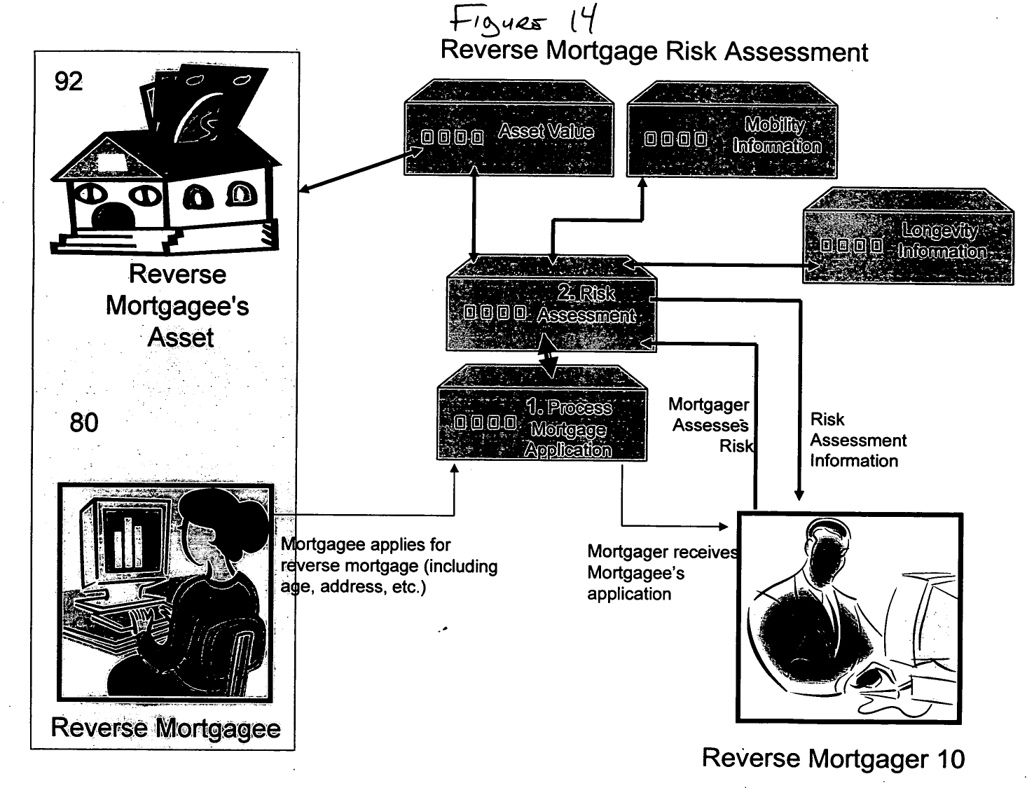

Periodically (but preferably no less than once a year) there will be an exchange of fixed and variable payments 18 and a mark to market payment 20. The administrative agent 30 will verify which individuals within the pool are still alive I-34. Preferably on the basis of that information, and the formula established for the payment of the variable payment, the administrative agent 30 calculates C-41 the variable payment 36 that the risk taker 4 owes to the risk seller 10 and notifies E-49 the risk taker 4. Based on mortality status I-34 and the updated Mortality probabilities I-31 provided by the contractually stipulated entity the administrative agent 30 calculates an updated projected expected payout 39. The difference C-40 between this value and the original expected payout (or in the case of the second and subsequent periods the recalculated amount) is the mark to market payment 38 that, depending on the actual outcome, could be owed by the risk taker 4 to the risk seller 10 or vice versa. This value is communicated E-47 to both the risk taker 4 and the risk seller 10. The administrative agent 30 also recalculates C-43 the amount that needs to be maintained in escrow and instructs the escrow agent 27 to return the excess to the respective parties. FIG. 15 illustrates additional details.

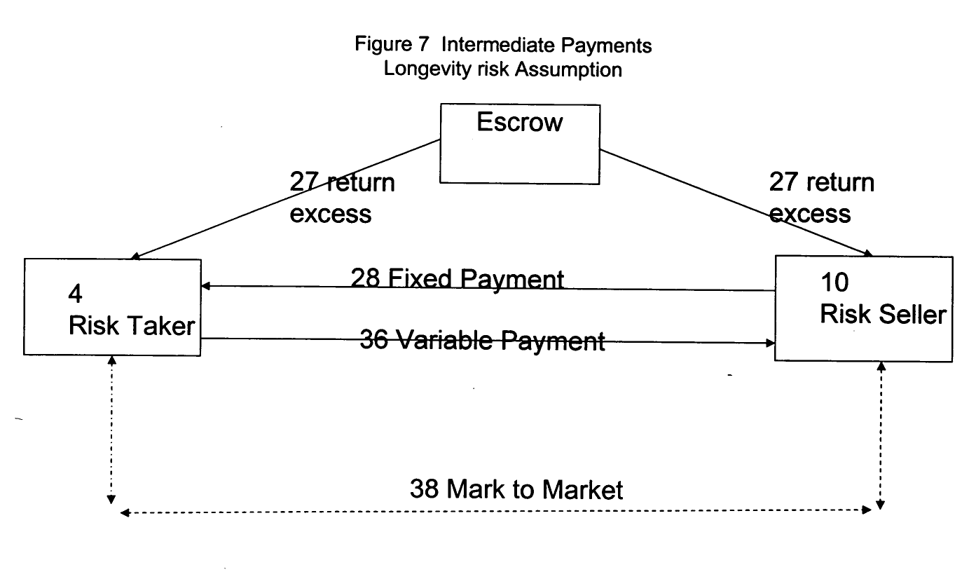

FIG. 7—Payment of Periodic Payments

The risk taker 4 will make the variable payment 36 determined by the administrative agent 30 to the risk seller 10 who in turn will make the predetermined fixed payment 28. The two amounts can be netted with only the difference paid. In addition the party that owes the mark to market payment 38 will pay that amount, which can also be netted against the difference between the fixed and variable payments. Depending on the actual mortality experience and naturally with the passage of time the amount FIGS. 5-14 that may be required to be maintained in escrow 15 declines and some amount can be returned 27 to the respective parties.

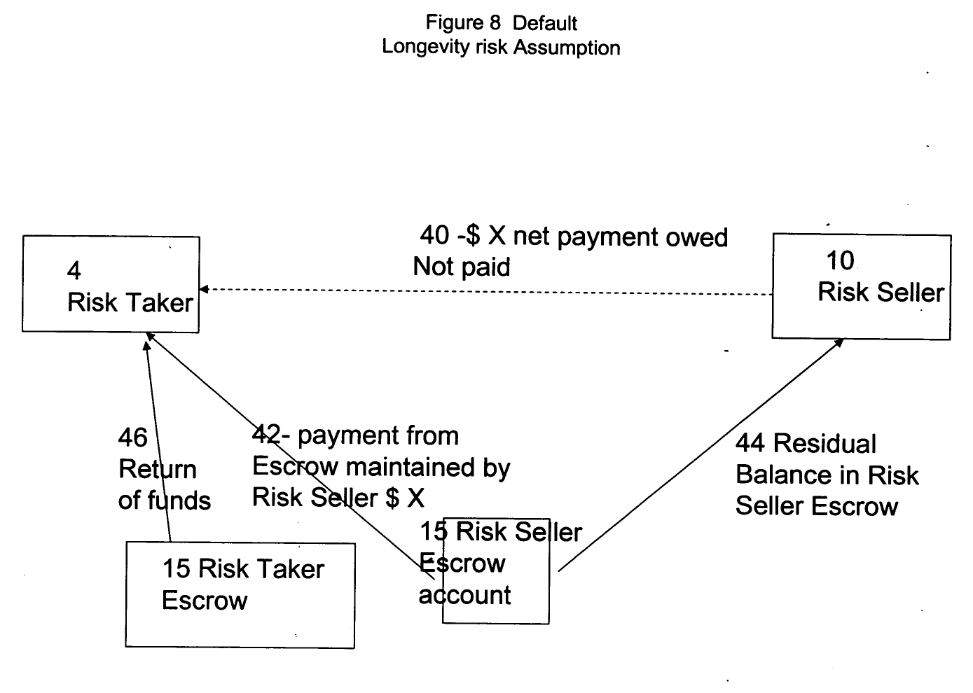

FIG. 8—Payments in the Event of Default

For illustrative purposes assume that the risk seller 10 failed to make the net periodic payment 40 to the risk taker 4. In this case, the risk taker 4 would receive a payment from the escrow 15 maintained by the risk seller 10 equal to the net amount 40 not paid by the risk seller 10. Any balance in the risk seller's 10 escrow account 15 would be returned to the risk seller 10. The funds maintained in the risk taker's 4 escrow account 15 would be returned to the risk taker 4 and the contract between the risk taker 4 and the risk seller 10 would be cancelled (in this example).

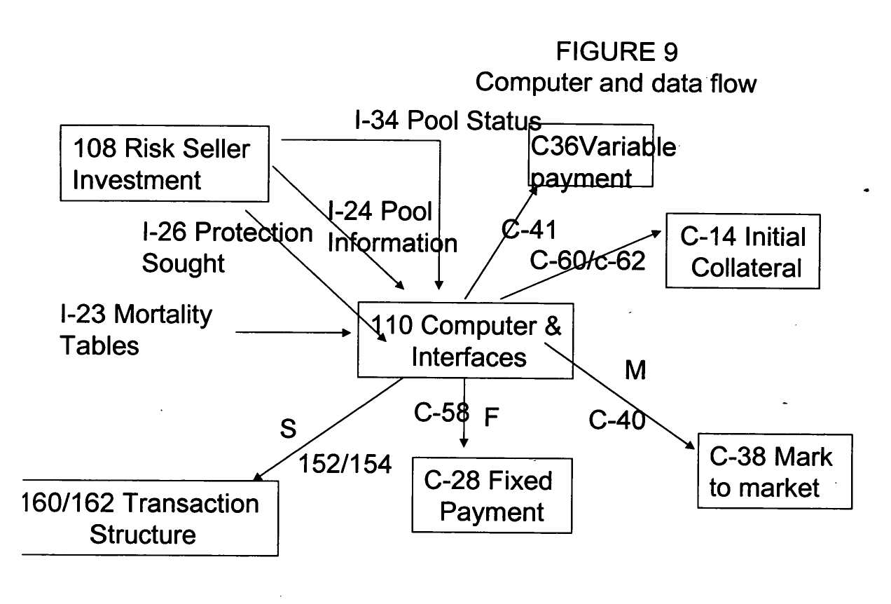

FIG. 9—Computer Generated Information

Preferably based on data supplied by the risk seller 10 on the pool I-24 and the protection sought I-26 the mortality tables I-64 the computer is able to generate C-58 a schedule of predetermined payments C-28 that risk seller 10 would be required to make to the risk taker (4).

Based on the fixed payment C-28 and the transaction structure 112 the computer is able to calculate the Initial Collateral C-14 that has to be placed in escrow 15 by both the risk seller 10 and the risk taker 4.

In the future, for payment dates based on the actual mortality status of the pool I-34 the, computer will be able to calculate C-41 the variable payment C-36 that the risk taker 4 will have to make to the risk seller 10 and the calculate C-40 the mark to market payment C-38 that would have to be made by either the risk taker or the risk seller to the other party.

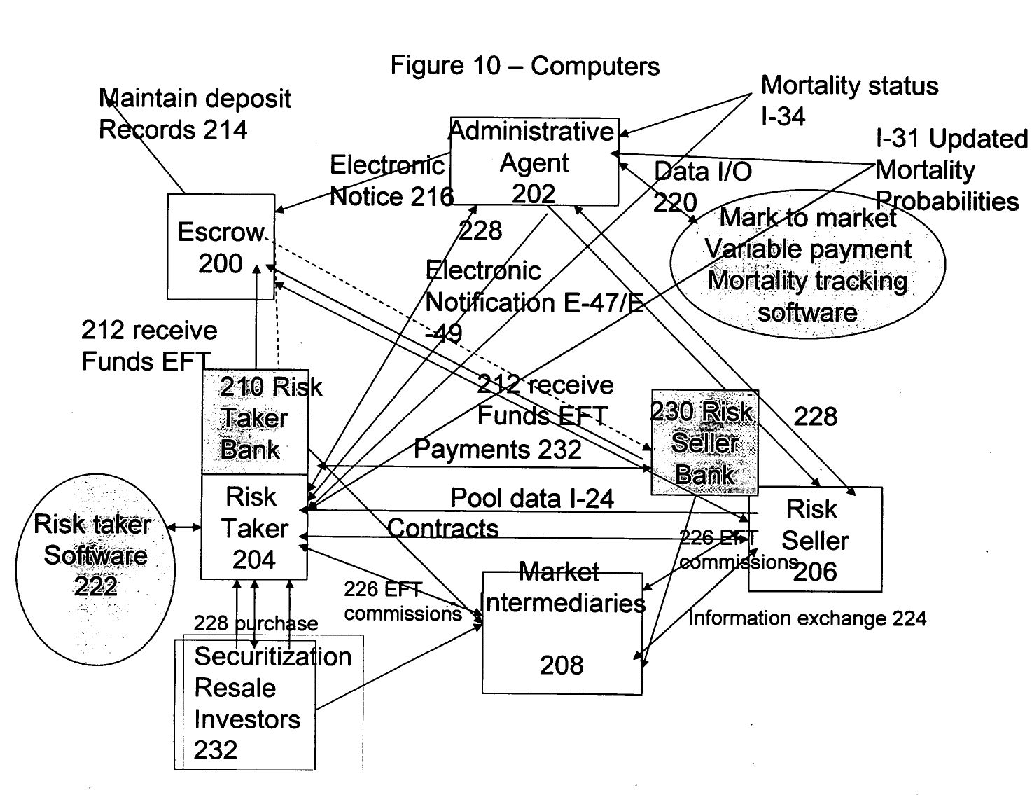

FIG. 10—Computers

Turn now to FIG. 10, which illustrates computers of parties cooperating in carrying out a representative embodiment. All computers are either stand alone main frames, networked computers or PC's equipped with secure electronic communication capability and requisite software such as Office or equivalent. In the case of financial institutions involved in the transfer of funds standard software and hardware of any institution that is part of the domestic or international funds transfer system.

In a simple illustration, each of the “computers” shown in a block in FIG. 10 can be a computer system comprised of a computer (e.g., an IBM, Hewlett Packard, or other personal computer) with processor (e.g., an Intel series processor or the like), a memory system (such as a hard drive, disk drive, etc.), an input device (such as a keyboard, mouse, modem, or the like), and one or more output devices, (e.g., a Hewlett Packard printer, a Dell monitor, a modem, or other such output device). The memory system can include an operating system such as Microsoft XP Professional (and its applications such as EXCEL, ACCESS, and WORD) to run the computer system, a word processing system (such as Microsoft Word) to process communications data and results into processed documents. The input device, such as a keyboard, receives input data either manually or electronically, and the output device, such as a printer or a CD drive, presents or stores output data. A system can be used to produce relevant documentation and to produce communications that are transmitted to another computer in the system (note that the system in FIG. 10 is illustrative and can be considered as comprised of one or more of these computers or other computers in communication therewith. Communications, including those sent and those received, can include the input data, processed results, and other relevant information as well as the processing logic itself, any of which can be shared via the network of computers as illustrated in FIG. 10.

Note that each computer system could be hard wired but preferably is in software for flexibility. In producing custom output, such as documentation, computer program instructions such as an EXCEL application, or an application that allows processing of numbers and logical evaluations can allow for the processing of information for the embodiment and controlling the respective system to cooperate with at least one other computer of the system to facilitate a transaction or part thereof, as may be desired. A computer system can also enable creation of a new data file, update of existing data file, process the data, display and input/edit of data form then processing of data), print the data as output and store the data. Noteworthy is the formation of custom documentation by computing a value and inserting the value into a pre-existing form document. Data files can be maintained historically, per contract, from its effective date. Data storage is physically in the computer or in a computer readable file kept offsite.

The word processing aspect allows for creating blank form documents, editing existing documents for any updates, printing such documents, and storing different versions of documents.

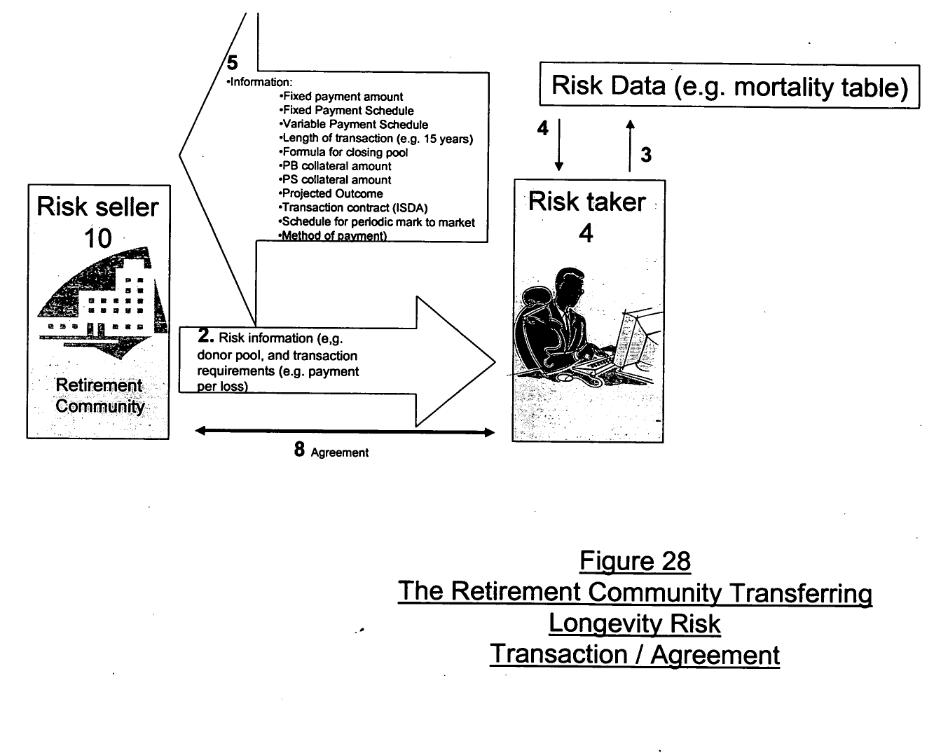

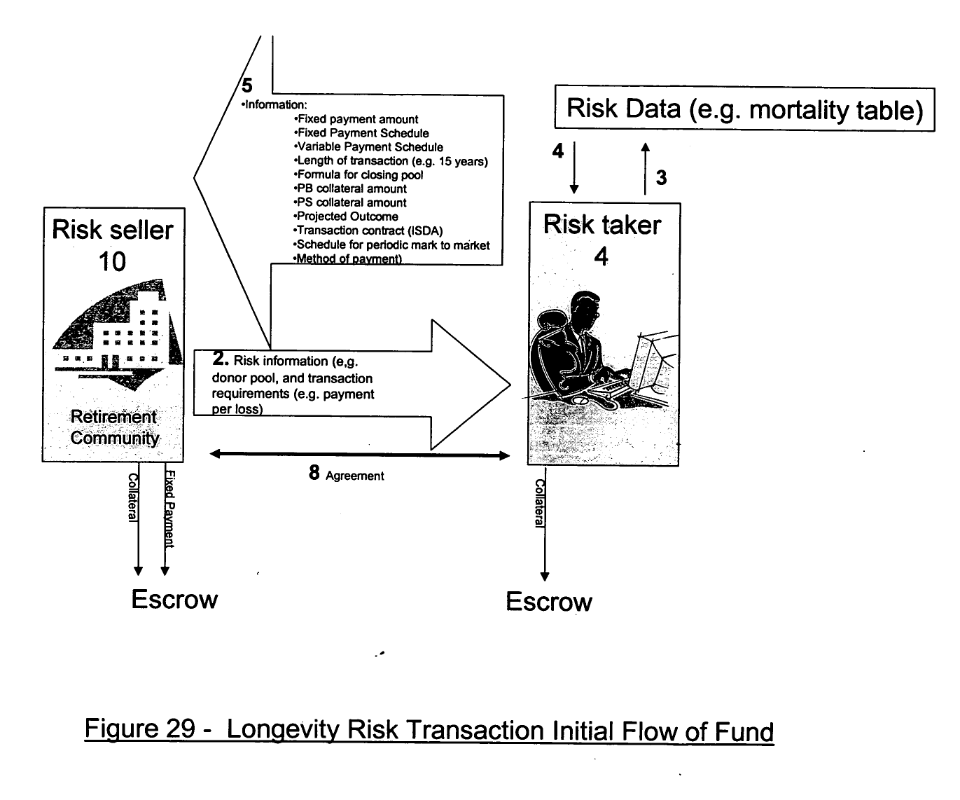

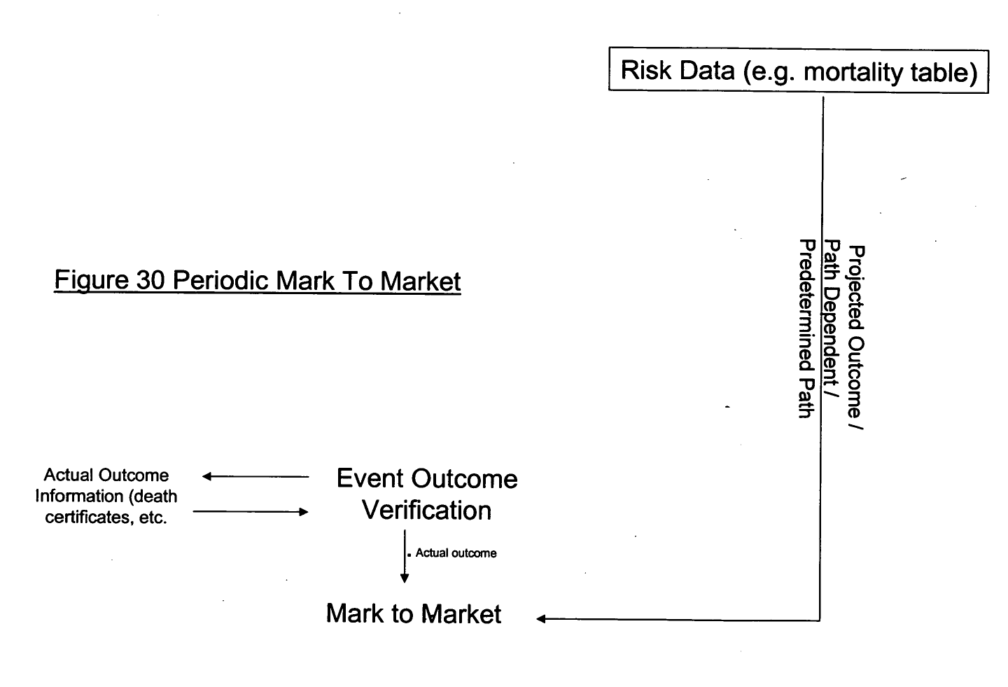

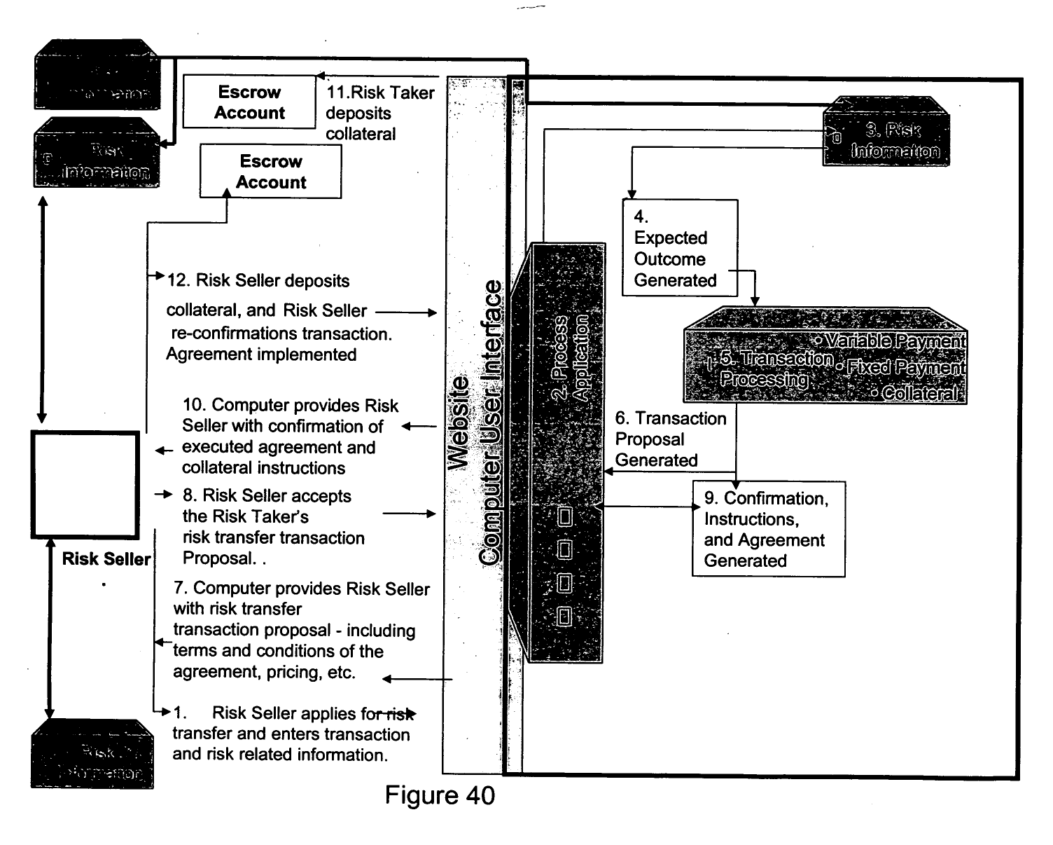

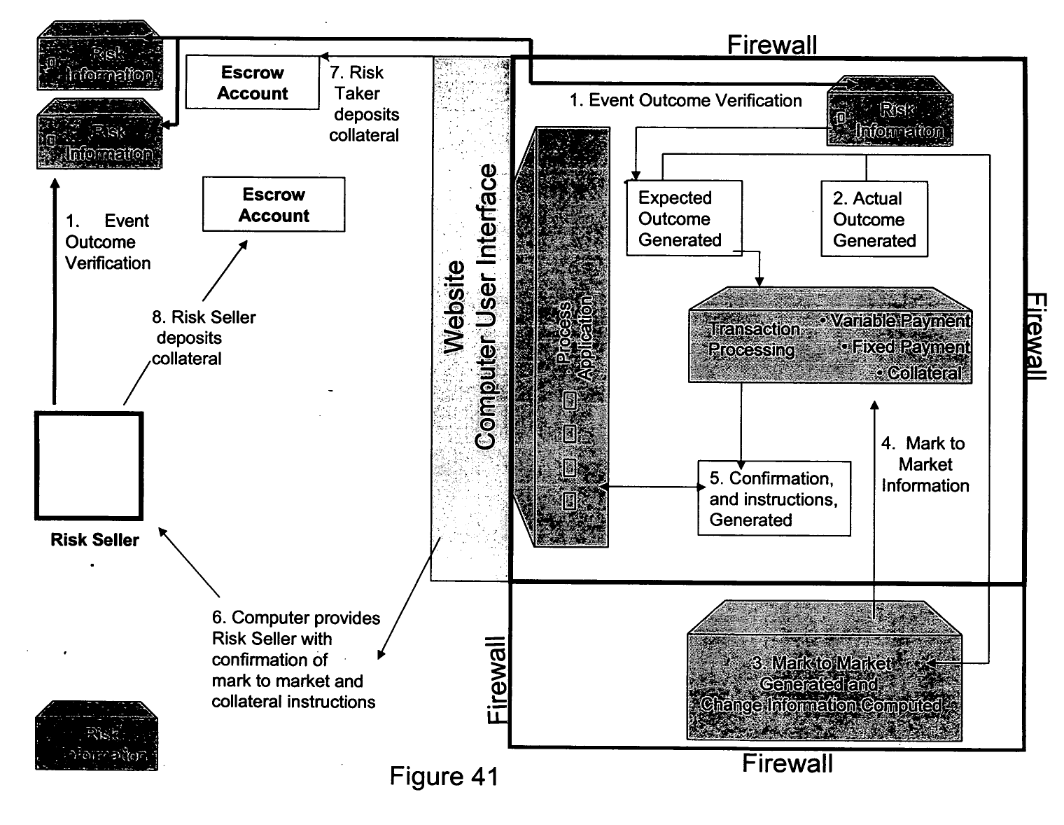

Turn now more particularly to the blocks of FIG. 10 illustrating the computer systems. Escrow agent (computer) 200 can be programmed to receive funds 212 via electronic funds transfer (EFT) or internal transfer from risk seller and risk taker banks FIG. 2-14. Escrow agent (computer) 200 can also be programmed to maintain records and calculate interest earned 214 of funds deposited by risk seller and risk taker in escrow FIGS. 2-15. In some embodiments, escrow agent (computer) 200 can receive electronic notification 216 of escrow funds to be released from the administrative agent 30 in FIGS. 6-27, via a suitable form of secure communication-encryption secure server. The escrow agent (computer) 200 can also be programmed to return excess funds 218 deposited in escrow via EFT to risk taker and risk seller 6 via their banks. See FIGS. 7-27. The escrow agent (computer) 200 can also be programmed to return all funds 218 in escrow at end of transaction via EFT to risk seller and risk taker via their banks; and/or to pay funds 218 from the escrow account via EFT or internal transfer in the event of a default by either party to non defaulting party. See FIGS. 8-42 and 44.

Administrative agent (computer) 202 can electronically receive mortality data FIGS. 6-34 on individuals within pool. Input data regarding each individual can be located into a data base and used for tracking mortality status payment terms of each individual within pool 220. Periodically, but preferably no less than once a year, there is input regarding changes in mortality status of individuals 220. Administrative agent (computer) 202 can be programmed to calculate variable amount to be paid by risk taker on periodic payment date, at 220 FIG. 6-C40. Administrative agent (computer) 202 can receive, electronically, updated mortality probabilities (if any) to be used for calculating mark to market from contractually agreed upon source. See FIG. 6 I-31 and input 220.

Administrative agent (computer) 202 can be programmed to calculate the mark to market payment (FIG. 6 C-45) utilizing actual mortality status and agreed upon mortality probabilities utilizing computer spread sheet 220. Administrative agent (computer) 202 can be programmed to provide electronic notification to risk taker of variable amount to be paid (FIG. 6 E-49), and/or provide electronic notification of mark to market payment to be made by either risk seller or risk taker (FIG. 6 E-47), and/or prepare contracts and documents using various types of office software and transmit to risk sellers and risk takers at 228. See the discussion herein regarding word processing, form documents, custom documents, and transmitting and receiving communications.

Risk Taker Bank (computer) 210 can be programmed to receive and/or pay out funds via EFT 232 to a risk seller bank computer, in connection with variable, fixed and mark to market payment. Risk Taker Bank (computer) 210 can be programmed to pay and receive funds via EFT from escrow bank (computer), and/or pay commissions to market intermediaries at 228.

Risk taker (computer) 204 can be programmed to allow, in some embodiments, receiving details on individuals within a pool and desired level of coverage electronically from risk sellers computer FIG. 4 I-24. Risk taker (computer) 204 can be programmed to calculate a fixed payment 222, and/or track mortality Data I-34, and/or track update mortality probabilities I-31. Once the risk taker has assembled a statistically valid pool of risk calculate optimum securitization strategy—amount of debt and rating of debt and amount of equity. 222. With regard to input for the risk taker (computer) 204, there can be input mortality probabilities into computer spread sheet (FIGS. 3 I-23), and/or input adjustment to mortality probabilities to account for mark up to cover return on capital and expenses FIG. 4 I-25. Risk taker (computer) 204 can be programmed to calculate expected payment per individual and aggregate for pool. by aggregating individual payouts FIG. 5 C-28, and/or receive payment notification (variable +/− mark to market if any) from Administrative agent (computer) FIG. 7 E-47/E-49. Risk taker (computer) 204 can be programmed to transmit an electronic notice to be received by the risk taker (computer) bank to make a required payment, if any. Risk taker (computer) 204 can be programmed to produce materials for resale of investments (e.g., in a secondary market with computer support for financial exchange institution(s)) from transactions discussed herein.

Risk seller bank (computer) 230 can be programmed to receive and pay funds via EFT 232 to risk taker bank (computer) in connection with variable, fixed and mark to market payment. Risk seller bank (computer) 230 can be programmed to pay and/or receive funds via EFT from escrow bank (computer) and/or pay commissions on behalf of risk seller to market intermediaries.

Risk seller (computer) 206 can be programmed to track financial exposure as a result of longevity risk (FIGS. 1-16). In some embodiments, Risk seller (computer) 206 can be programmed to transmit details on individuals within a pool and desired level of coverage electronically to risk taker (FIG. 4 I-24), and/or receive payment notification (Mark to market less variable payment) from administrative agent (computer) FIG. 5 E-47/E-49, and/or transmit electronic notice to the risk seller bank (computer) to make a required payment, if any.

Market intermediary(ies) (computer) 208 (e.g., insurance brokers, advisors, investment/merchant banks, other financial institutions, hedge funds, etc.) can be programmed to produce presentation material and theoretical/hypothetical pricing for risk sellers and/or risk sellers 224, as exemplified by FIG. 3 herein. Market intermediary(ies) (computer) 208 can be programmed to receive pool data from risk sellers 224 electronically, and/or input data into a spread sheet, and/or calculate theoretical fixed payments that would have to be made by risk sellers 224.

Assembled pool security buyers (computers) 232 can be programmed to prepare contracts and documents 228. See the discussion herein regarding word processing, form documents, custom documents, and transmitting and receiving communications. Assembled Pool Security Buyers (computers) 232 can be programmed to transfer funds via EFT the risk taker computer and/or market intermediary(ies) computer 208. Assembled Pool Security Buyers (computers) 232 can be programmed to send and/or receive information with the risk taker computer and/or market intermediary(ies) computer 208.

As an overlay to computing in FIG. 10, note that there can also be a distribution system (with commensurate computer support) for each area comprised of any combination of:
marketing directly—where a administrative agent (computer) 202 is directly marketing to the Risk sellers;
developing computer-to-computer communication-enabled strategic relationships—with parties who have a related specialization, services, or possess trusted advisor relationships. These parties may market to the Risk sellers directly, or provide referrals to the administrative agent.
tapping existing distribution channels—via the administrative agent tapping such as insurance and reinsurance intermediaries with computer-to-computer communication.

Analytics can be made available via an electronic transfer medium or by accessing on the world wide web. Such analytics can allow risk sellers and risk takers to conduct what if studies, to gauge the effectiveness of the risk transfer allow for a modeling of lumpiness and dispersion with a pool; to allow them or their advisor to communicate better with existing and potential investors, raise more debt and equity and purchase additional assets. Investment managers can use these analytics to market to risk sellers who need to coordinate their investment portfolios and their fixed payments.

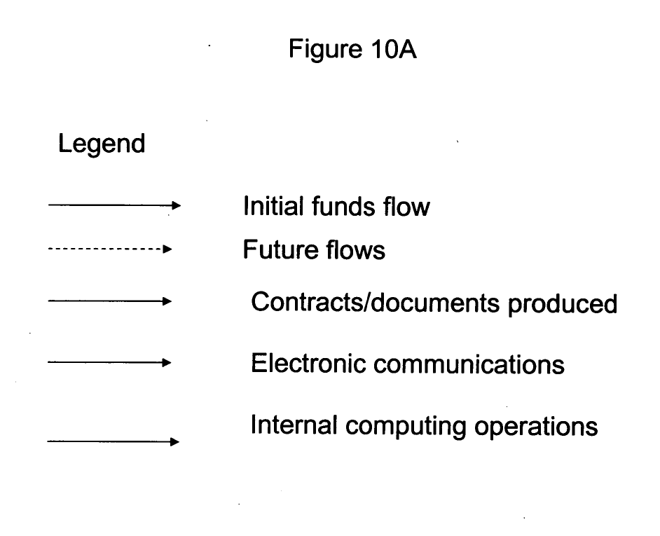

### FIG. 11—Charitable Gift Annuity Embodiment

Consider now several other embodiments in appreciation of the robustness of the greater ideas conveyed by the teaching examples herein. Imagine that a donor 80 makes a donation 86 to a charity (risk seller 10) under which the charity agrees to pay the donor 80 and specified amount as an annuity payment 88 for the remainder of the donor's 80 life. Approximately 50% of the donation 86 is used to fund the programs of the Charity 88 and the remaining 50% is invested 92. The expectation is that the return (principal+interest) on the investment 90 will be sufficient to meet the Charity's annuity obligation 88. If the donor 80 should live longer than the Charity has assumed the return on the investment 90 will not be sufficient to meet the obligation resulting in a loss to the Charity. Alternatively, if the donor doesn't live as long as expected the investment return 90 will be greater than the payments 88 to the donor 80 and it will result in a windfall to the Charity.

However, the Charity has the option of transferring this risk. In this case, a risk taker makes a variable payment 36 to the Charity. The formula used to calculate the variable payment is set to ensure that the variable payment will be equal to the Charity's obligation to its donor(s), i.e., variable payment 36 and annuity payment 88 are equal. The Charity's investment 92 is adjusted so that the return (principal and interest) of the investment 90 will be equal to the fixed payment 28 that is made to the risk taker 4.

Because the fixed payments are predetermined and irrevocable irrespective of the actual mortality of the donors, the effect of the hedged transaction is to guarantee that actual outcome i.e. the Charity gets to use exactly 50% of the initial donation 86 for its programs is exactly the same as what the Charity expected the outcome to be.

One attractive attribute of embodiments herein is that, by reducing or eliminating credit risk as a consideration, it is possible to break down the risk taking function to appeal to two distinct investor segments—those interested in the assembling of statistical pool a relatively short term investment (aggregation) and those interested in holding the risk till maturity a long term investment. The elimination of credit risk allows one group of investors to assemble and then assign their interests to another group of investors to hold. If credit risk were a consideration were a consideration, it could require the consent of all risk sellers (a daunting task) or alternatively finding an investor who had both a short term and long term investment appetite (difficult).

If the risk taking basis is accurate than the risk taker 4 should collectively on all of its risk assumptions FIG. 2 have a positive cashflow 164 (total fixed payments minus total variable payments+mark to market). There is a probability (confidence interval) that can be ascribed to how large this cashflow will be. The lower the confidence interval the higher the cashflow.

Using a very high confidence interval (e.g., 99%), it is possible to determine the expected cashflow over the life of the risk assumptions. Because this cashflow has such a high probability of occurring (99%), it is possible to get a loan/debt 150 that is repaid from the cash flow 152. The amount of the loan 150 can then be used to repay the original investment FIGS. 1-20 made by the investors FIGS. 1-2.

Consider the Table 5 below.

TABLE 5
CASHFLOW SUPPORTING SENIOR DEBT
(BASED ON 99.5% CONFIDENCE INTERVAL)
INTEREST RATE ON SENIOR DEBT 9.50%

| ALE + 0.79 | | | PRINCIPAL | | |
|---|---|---|---|---|---|
| POOL | | INTEREST | REPAYMENT | PRINCIPAL | DEBT |
| CASHFLOW | | SENIOR | DEBT | OUTSTANDING | COVERAGE |
| | | | | $12,700,000 | |
| 1 | $2,295,356 | (1,206,500.00) | (1,088,856.44) | $11,611,144 | 1.00 |
| 2 | $2,218,531 | (1,103,058.64) | (1,115,472.55) | $10,495,671 | 1.00 |
| 3 | $2,245,895 | (997,088.75) | (1,248,805.90) | $9,246,865 | 1.00 |
| 4 | $2,049,748 | (878,452.18) | (1,171,295.63) | $8,075,569 | 1.00 |
| 5 | $1,802,351 | (767,179.10) | (1,035,172.09) | $7,040,397 | 1.00 |
| 6 | $1,671,094 | (668,837.75) | (1,002,255.75) | $6,038,142 | 1.00 |
| 7 | $1,526,283 | (573,623.45) | (952,659.66) | $5,085,482 | 1.00 |
| 8 | $1,235,728 | (483,120.79) | (752,606.94) | $4,332,875 | 1.00 |
| 9 | $1,066,235 | (411,623.13) | (654,611.66) | $3,678,263 | 1.00 |
| 10 | $1,074,851 | (349,435.02) | (725,416.07) | $2,952,847 | 1.00 |
| 11 | $872,542 | (280,520.49) | (592,021.59) | $2,360,826 | 1.00 |
| 12 | $729,715 | (224,278.44) | (505,436.54) | $1,855,389 | 1.00 |
| 13 | $653,613 | (176,261.97) | (477,350.55) | $1,378,039 | 1.00 |
| 14 | $465,630 | (130,913.67) | (334,716.42) | $1,043,322 | 1.00 |
| 15 | $1,245,379 | (99,115.61) | (1,043,322.20) | $0 | 1.09 |

However, at a somewhat lower probability (e.g., 86%), there is a larger cashflow than what is needed to pay the interest and principal 152 on the loan 150. This surplus accrues to the benefit of the investors FIGS. 1-2. They can sell their right to this cashflow 156 to another group of equity investors who will then receive all the residual cashflow 154 after payment of the intrest and principal on the loan.

Now consider the Table 6 below.

TABLE 6
CASHFLOW FOR PRICING EQUITY TRANCHE
(BASED ON 86% CONFIDENCE INTERVAL)
EQUITY DISCOUNT
RATE 22%

| ALE + 0.36 | | | | |
|---|---|---|---|---|
| POOL | | PREFERRED | NET | |
| CASHFLOW | | DEBT | EQUITY | CASHFLOW |
| 1 | $3,520,669 | ($2,295,356) | $1,225,312 | |
| 2 | $3,339,519 | ($2,218,531) | $1,120,988 | |
| 3 | $3,083,153 | ($2,245,895) | $837,258 | |
| 4 | $2,925,276 | ($2,049,748) | $875,528 | |
| 5 | $2,895,666 | ($1,802,351) | $1,093,315 | |
| 6 | $2,689,757 | ($1,671,094) | $1,018,663 | |
| 7 | $2,460,674 | ($1,526,283) | $934,391 | |
| 8 | $2,228,707 | ($1,235,728) | $992,979 | |
| 9 | $1,995,004 | ($1,066,235) | $928,769 | |
| 10 | $1,793,130 | ($1,074,851) | $718,279 | |
| 11 | $1,597,647 | ($872,542) | $725,105 | |
| 12 | $1,353,715 | ($729,715) | $624,000 | |
| 13 | $1,132,903 | ($653,613) | $479,290 | |
| 14 | $912,324 | ($465,630) | $446,694 | |
| 15 | $1,644,743 | ($1,142,438) | $502,305 | |

| | | |
|---|---|---|
| SALE PREFERRED | $12,700,000 | |
| SALE EQUITY | $4,243,267 | |
| 2ND YEAR MARK TO MARKET | | $710,900 |
| CAPITAL | | |
| RETURNED | $421,003 | |
| NET PROCEEDS | $18,075,171 | |
| ORIGINAL INVESTMENT | | $13,000,000 |
| NET PROFIT ON SALE | | $5,075,171 |

Effectively the initial investors FIGS. 1-2 would have taken the risk of assembling (the sale or the loan couldn't happen without a statistically valid pool) but then sold out to a second group of investors who would hold the transaction to maturity.

In another embodiment used to teach the broader principles herein, imagine that a longevity risk transfer is carried out without one, and preferably without either of:
1. An insurance company; and/or
2. A credit worthy counter party

That is, embodiments herein make it possible for two parties neither of whom is an insurance and/or a credit worthy counter party to enter into a longevity risk transfer contract while simultaneously being assured that the economic cost of the longevity risk will be covered. This can be carried out as follows:
1. Structure of the risk transfer transaction into a single transaction that uses:
   a. A swap contract rather than an insurance contract;
   b. An escrow account; and
   c. A mark to market payment.
2. A “mark to market” calculation in the context of a risk transfer is the difference between a contract price and a market price of the risk transfer; it is reflective of the economic cost (benefit) of the risk being transferred.

Using a “mark to market” calculation allows a payment/collateral arrangement that ensures that both parties to a risk transfer contract are assured at all times of receiving the full value of their economic exposure. Therefore they are, irrespective of whether they are an insurance company or not or whether they have a high credit rating or not, able to confidently deal with one another.

Embedded Longevity Risk—spans numerous products and businesses, as illustrated by the following particular embodiment (which are intended to supplement the Charitable Gift Annuities example above).

### FIGS. 13-22 Reverse Mortgage Embodiment

FIGS. 13-22 illustrate an embodiment for a reverse mortgage hedge.

Reverse mortgages provide senior citizens, e.g., age 62 and older, with cash payments and possibly a credit line in exchange for the equity in their homes. Although the products have been in the market for some time, their risks are not yet well understood. The main risk factors are the longevity risk, mobility of the underlying borrowers, and the net liquidation value upon the sale of the underlying property.

A homeowner applies for a reverse mortgage from a mortgage lender for a commitment to pay a homeowner periodic payments for as long as a homeowner remains in a home. An expectation is that a mortgage lender will make a financial return on a asset sufficient to cover all periodic payments (a periodic payment could be as long as the homeowner is alive). If a homeowner should live longer than an estimated life expectancy, or estimated rate of acquiring an asset by a lender, a financial return would be impacted. In a reverse mortgage currently a lender prices into the loan that the homeowner will live well beyond their life expectancy (HUD prices life expectancy at 99 years) thereby the risk is charged to the loan value or periodic payment.

A method of hedging longevity risk can use embodiments herein such that a mortgage lender will now enable the risk taker to provide a financial consequence of a homeowner living beyond a estimated period. The present unrealistic life expectancies result in small loan to asset values (e.g., less than 50% for an 80 year old with a life expectancy of 7.8 years) which makes them a poorly designed product from the borrowers perspective. This probably accounts for their limited use-only 5% of all reverse mortgages are private label.

The basic problem has been that life expectancy is a statistical measure, and as with all statistical measures, is of little predictive value as it applies to a single individual. With statistical measures, as the sample size increases, so does the predictive value of the sample. Typically a life expectancy sample size of 1000 discrete individuals is considered to be statistically significant. However, few reverse mortgage lenders will have enough of these loans to have predictive value. The probability that somebody will live longer than their life expectancy is 50% (this in fact is the definition of life expectancy), the probability of a gain or loss on someone living beyond a life expectancy is a coin toss. This is a reason for a risk transfer.

ALERTS can be used as a means for transferring longevity risk to enable the mortgage lender to remove a financial risk they have been pricing defensively (99 years). This risk transfer of longevity risk would permit the lender to extend larger loans against the asset. The effect of the hedge is to guarantee an actual financial outcome on the financial exposure to the owner living too long and impacting the internal rate of return on the loan. A higher loan to asset value can be offered making a better product for the consumer.

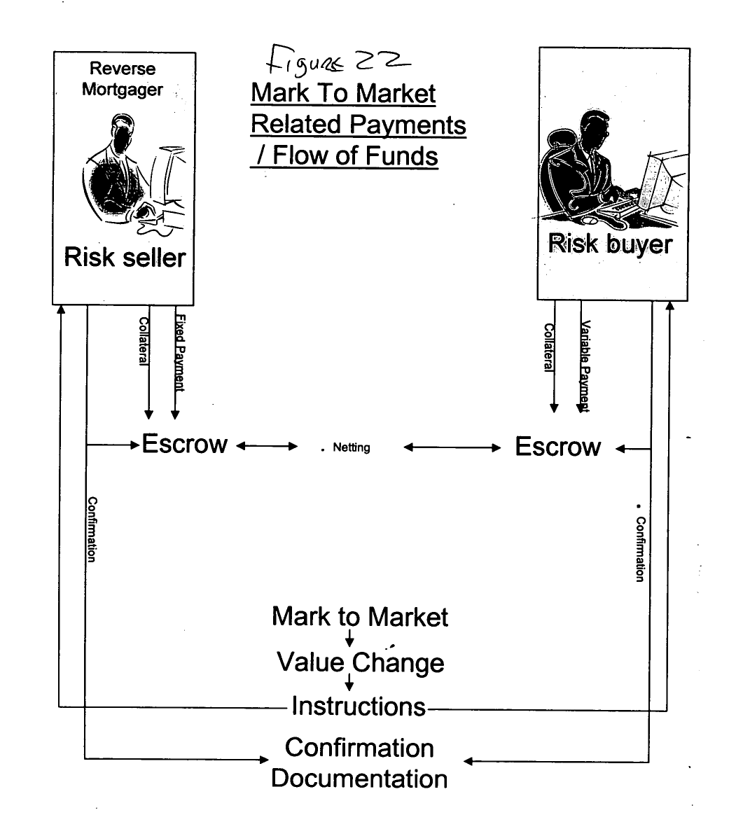

### FIG. 23-31 Retirement Communities Embodiment

FIGS. 23-31 illustrate an embodiment for a retirement community. Many retirees have interest in purchasing interest in retirement communities, and enter into an agreement where for a payment the retiree secures an interest to live within a retirement community for the remainder of their lives. In exchange for payment, the retirement community is obligated to provide their clients with various amenities—such as residence, food, healthcare, nursing home and hospitalization care, as well as various forms of entertainment.

As such, the retirement community has longevity risk associated with the clients living longer than expected. If a retirement communities resident lives longer than expected, the retirement community may have a negative financial consequence. Longevity risk can affect the retirement community's financial performance and its ability to meet its obligation to the retiree.

A Retirement community can become longevity risk seller and transfer the longevity risk to a risk taker.

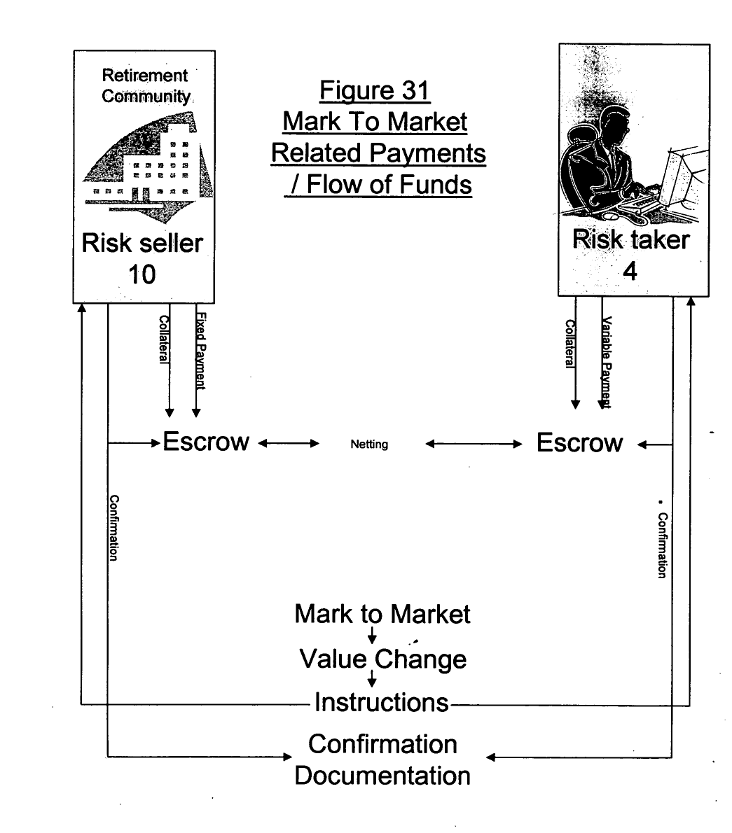

### FIGS. 32-39—Pension Embodiment

FIGS. 32-39 illustrate an embodiment for a pension.

Many companies provide their employees with retirement benefits such as healthcare benefits, and retirement pension income benefits. FIG. 32 is illustrative of a company that has retired employees to which the company has pension income obligations.

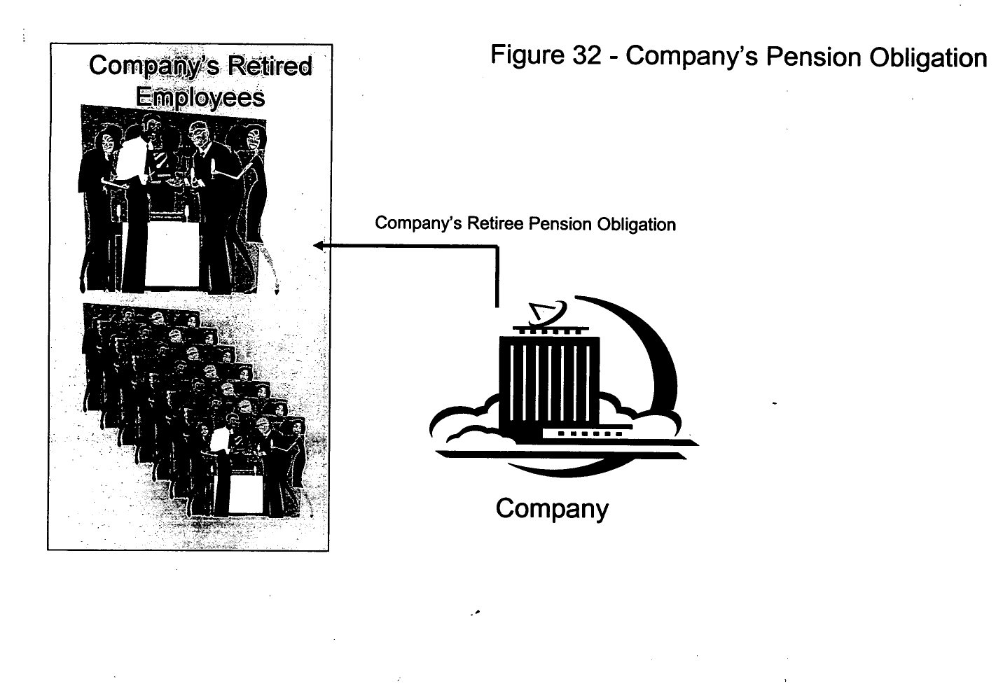

There are three primary risks associated with pension income obligations. FIG. 33 is illustrative of these risks. One risk is the actual amount of the payment due to each employee (e.g. paid each month). This is usually a function of an employee's compensation during the employee's last few years of employment. Accordingly, most often the amount is determined at retirement (and no longer an uncertainty/risk).

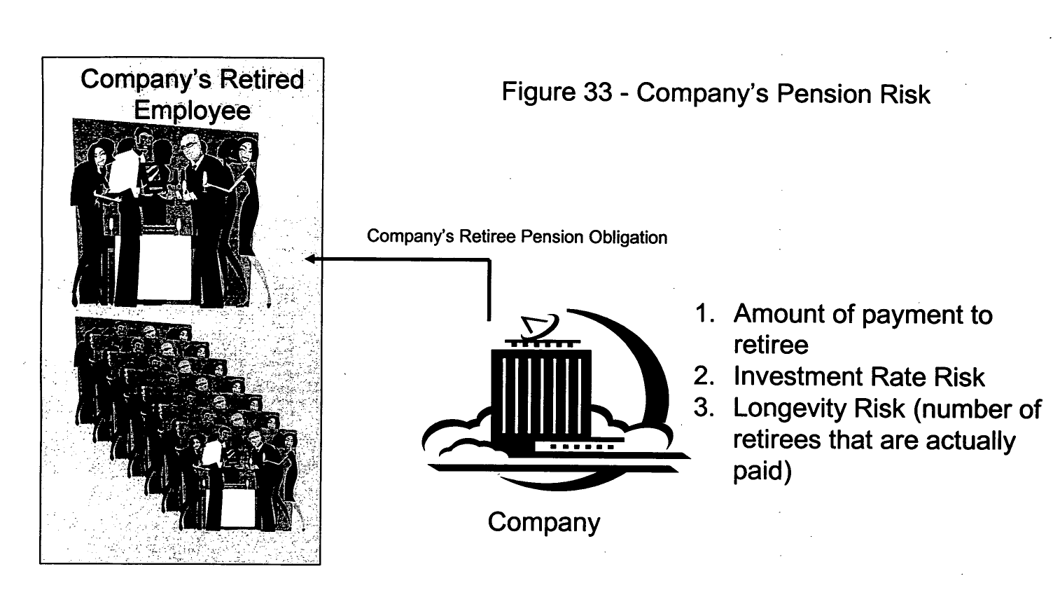

Another risk is longevity risk, the risk that employees may live longer than expected and accordingly, increases the number of payments paid by the company to the employees. FIG. 34 is illustrative of the impact of the risks on the company's pension reserves and its ability to meet its retiree pension obligation. The increase in longevity risk and in the number of payments will negatively affect the amount within the pension reserves. Another risk involves the investment rate and ensuring that the rate of return on the pension reserves will be sufficient to meet the company's obligation.

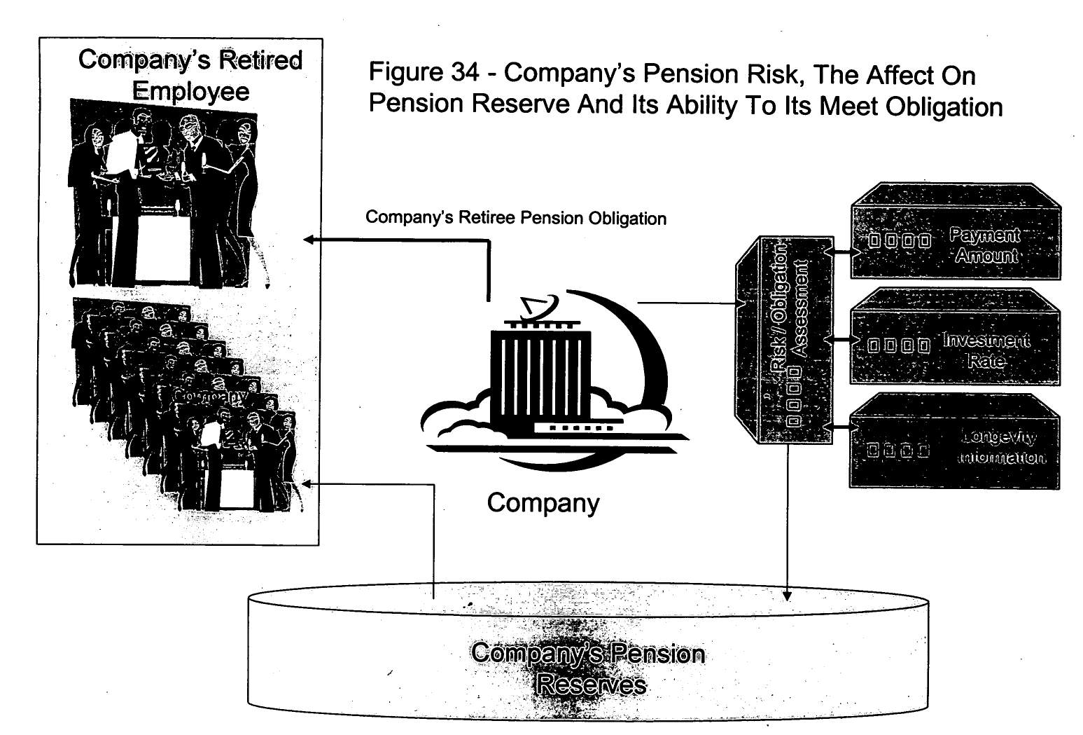

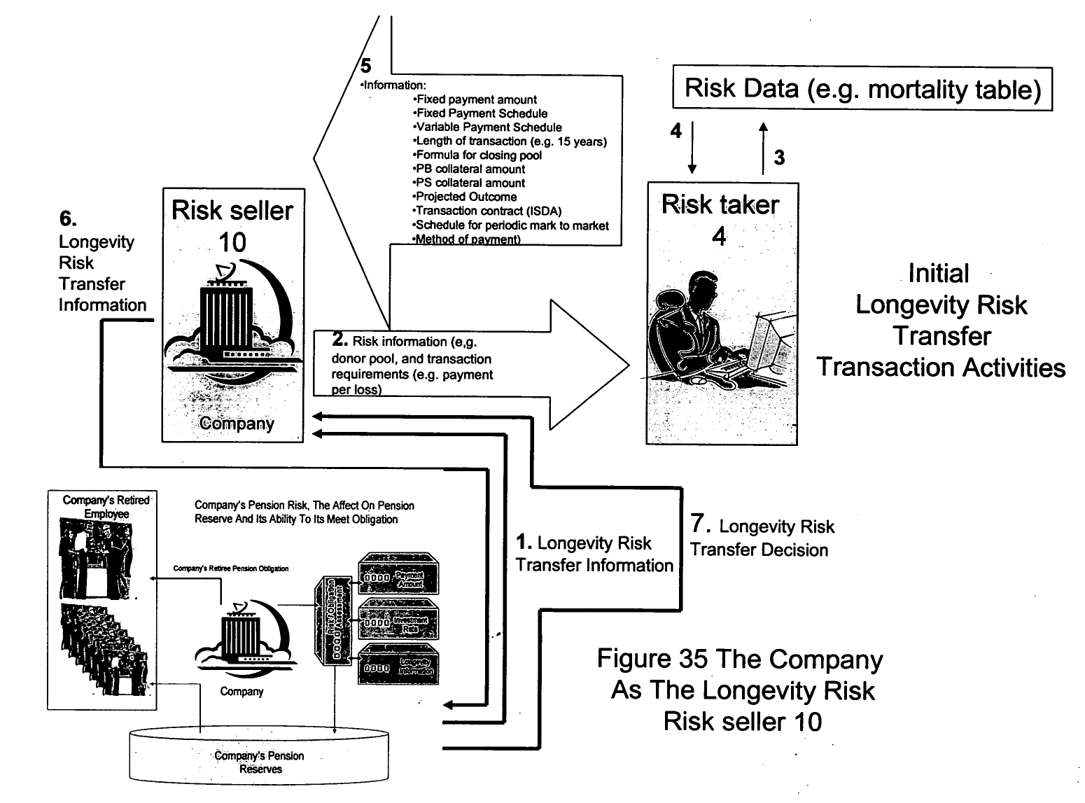

FIG. 35 is illustrative of the company as a longevity risk seller, and the company's involvement in the initial transaction activities. Through the initial longevity risk transfer transaction process the company evaluate if transferring their longevity risk produces sufficient value. If the transaction produces sufficient value, as illustrated in In FIG. 36, the company can enter into a transaction agreement with the risk taker and transfer their longevity risk to a third party. The agreement contains provision for executing, maintaining, and closing the transaction, and is inclusive of collateral and mark to market requirements.

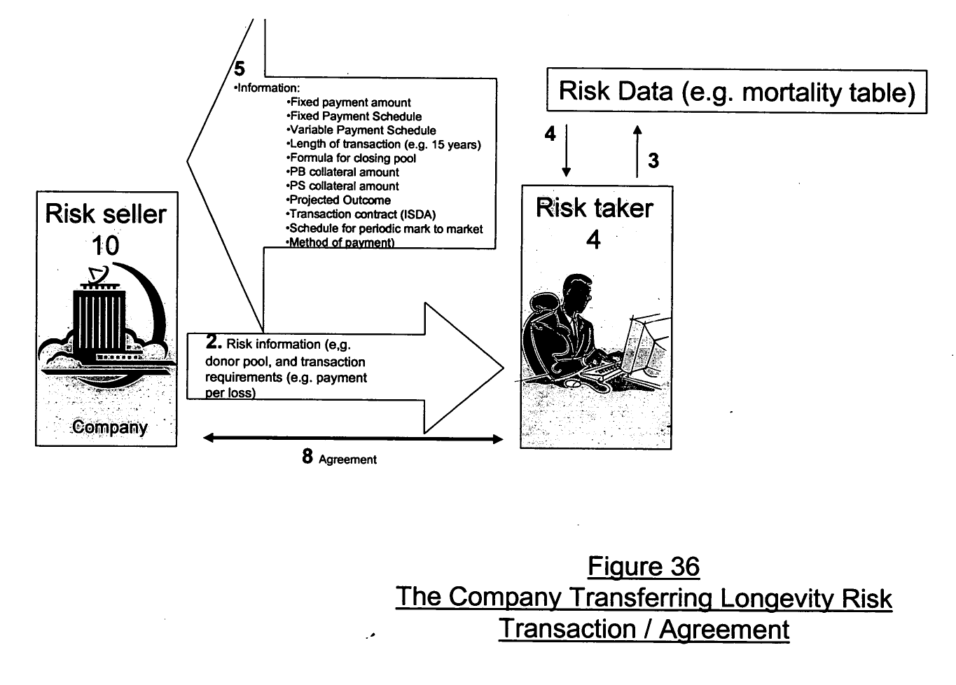

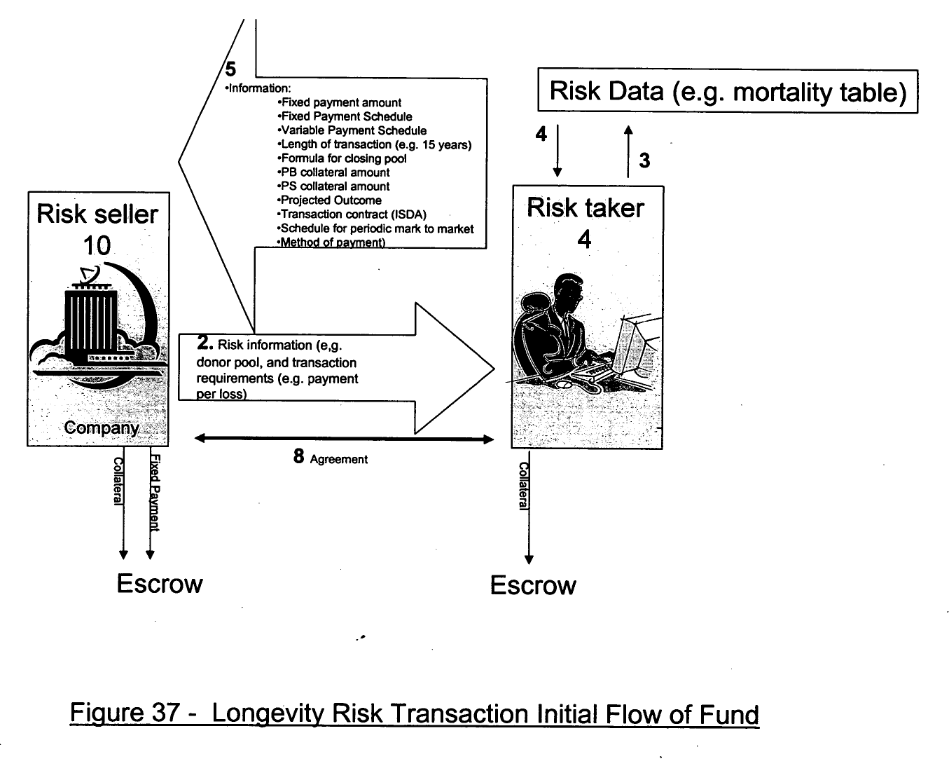

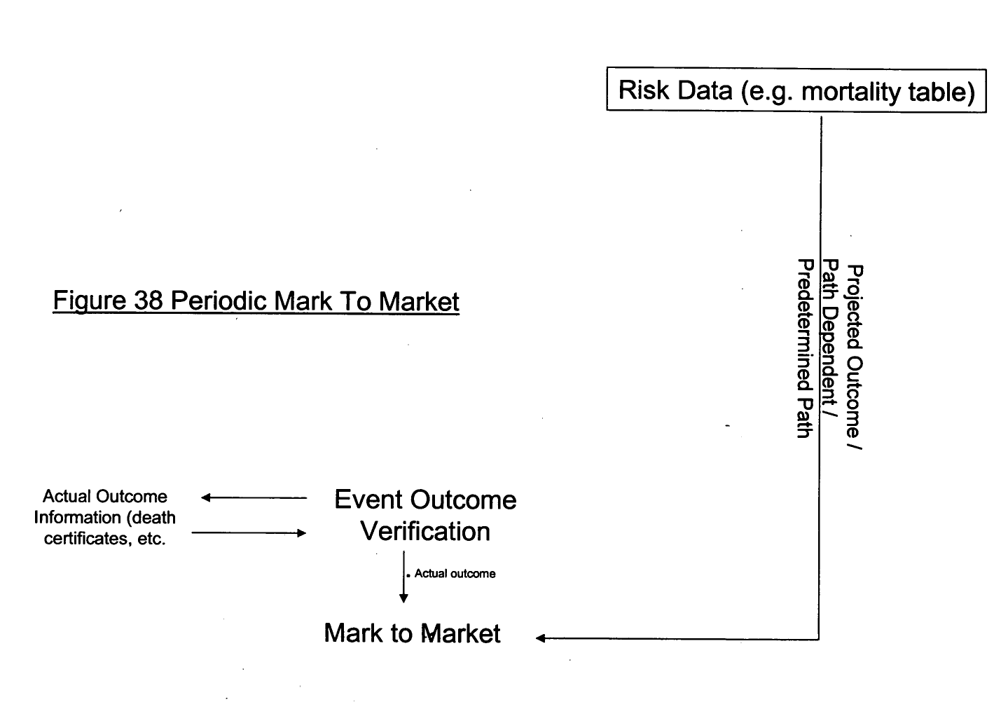

FIG. 37 is illustrative of the risk seller/company and the risk taker collateralizing their obligation with the risk transfer transaction with an escrow account and the initial flow of funds. FIG. 38 is illustrative of the periodic mark to market provision within the risk transfer transaction agreement. FIG. 39 is illustrative of the mark to market and the subsequent flow of funds and changes to required collateral and escrow account.

Securitized Transaction

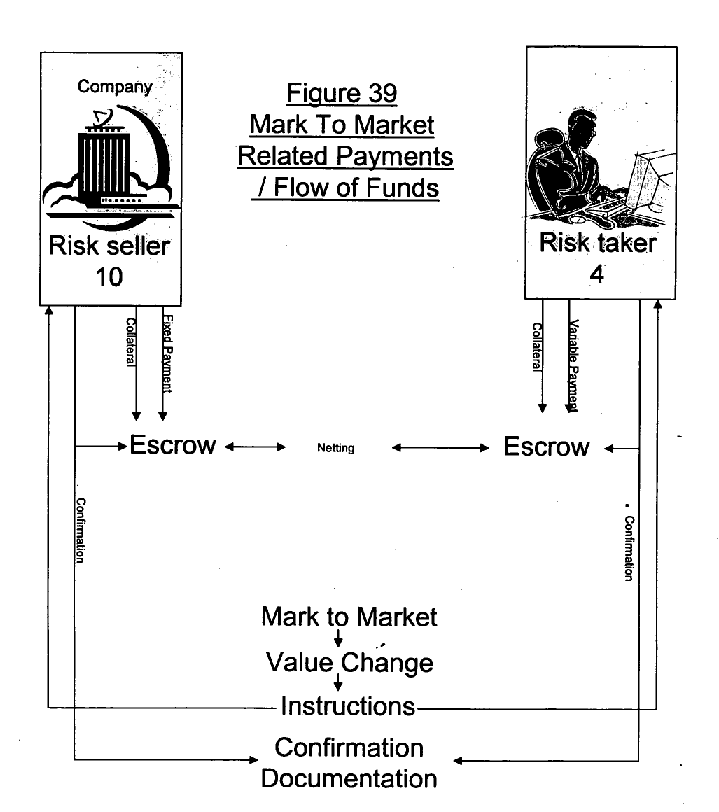

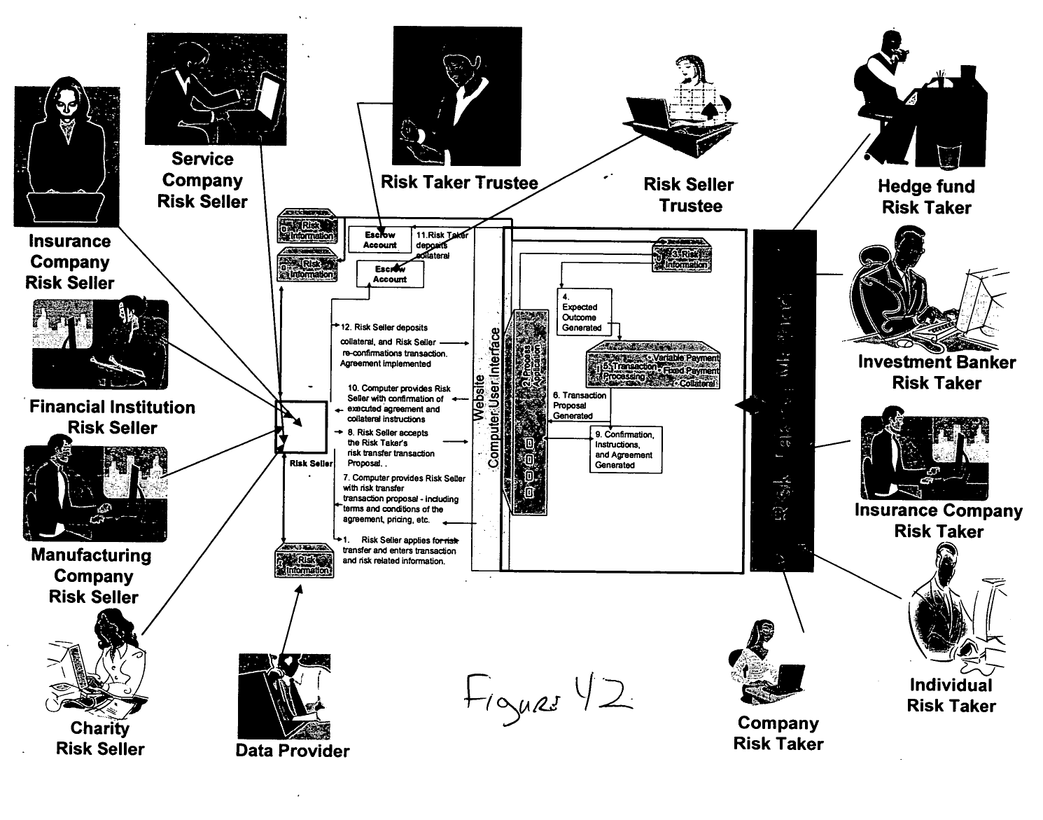

FIGS. 40-44 illustrate a securitization transaction of the assembled risk pool of an embodiment: Transferring of the financial consequences of risk and the securitization of the transfer.

In this risk transfer embodiment, the risk taker and risk seller agree to place in escrow an initial margin and they also agree to mark to market the originally expected outcome minus the reprojected expected outcome. The escrow account and the mark to market payments eliminates credit risk, which in turn makes the (ALERTS) method transferable. This enables pooling the risk (e.g., longevity risk) for subsequent sale to an investor.

Coupled with the increasing demand for transferring risk is an increased demand from investors who are looking for investments that are not correlated to either a bond or equity markets, e.g., “Insurance risks.” Except for a few hedge funds, who are taking some risk directly, most other investors have chosen to take these types of “insurance risks” by participating in the risk pools of existing insurance companies e.g. reinsurance Side Cars, CAT bonds, Industry Loss Warranties, etc. This results in an opportunity for an organization (“Pooling Agent”/“Underwriter”) utilizing the method, to use their risk capital to support the underwriting and assembling of a statistically valid pool of risk directly from the risk seller, which subsequently is securitized for sale to investors looking for alternative investments. Investors have already demonstrated a willingness to assume longevity based risk.
1. There have been securitizations of life insurance products and most recently a longevity linked bond issue.
2. Moody's has already begun to rate Reverse Mortgage securities based on the actuarial tables and assumptions used to estimate LR. Therefore, if need be, it will be possible to get a rating on the pools in order to improve the price and increase demand.
3. There is also a substantial market in Viatical or Life Settlements (a Longevity Risk based investment); thus demonstrating an investor willingness to take this type of risk.

The present embodiment enables investing by the broader investment intermediaries to participate in non-traditional risks.

Hypothetical Exemplary Transactions

First Hypothetical Transaction

Imagine that a Risk seller enters into a transaction with the Risk taker, to transfer the LR associated with a defined pool of risk. Under the terms of the transaction, the Risk seller agrees to make a series of fixed payments determined at the inception of the transaction to the Risk taker; in exchange the Risk taker pays the Risk seller a series of variable payments related to the actual outcome of the risk

This transfers the longevity risk from the Risk seller to the Risk taker. To guard against the risk of non payment (“Credit Risk”) since no funds exchange hands initially, both the Risk seller and Risk taker agree to place in escrow an initial margin (collateral) and they also agree to “mark to market” the contract.

The escrow account and the “mark to market “payments eliminate Credit Risk” as a consideration—which in turn makes the transaction transferable. This is usually required for being able to pool the risk for subsequent sale to an investor(s).

For illustrative purposes, assume that there are 10 developers of senior communities each of whom has entered into agreements with their residents that in exchange for a single payment the resident is entitled to live rent free for as long as the person is alive. For ease of description we are assuming that each of the developers has a 100 clients all male and every one of them has just turned 80 years. The rental value of the property is $2,500/month or $30,000/year. (In practice the pool will consist of both men and women, of different ages. While this changes the economics it doesn't have an impact on the mechanics only complicates the calculations.) And that the Developer would like to transfer the associated longevity risk.

Under terms of the transaction, each developer (Risk seller) enters into a 15 year agreement with the Risk taker under which the developer and the Risk taker agree to make periodic payments to one another (semi-annual or annual) as follows:
1. The developer's periodic payments to the Risk taker (which may or may not be a constant amount) are agreed to at the inception of the transaction and remain fixed at those levels for the duration of the transaction (the fixed payments);
2. The Risk taker pays the developer a variable amount based on the actual mortality of the developers clients (the variable payments)
3. Both the developer and the Risk taker place an amount in escrow on which they will receive interest;
4. Both the developer and the Risk taker agree to make “mark to market” payments at least once year.

All payments that are owed by one party to the other will be netted and only the party with net obligations will make the payment.

The fixed payments that developer will make to the risk taker can be calculated as follows:
1. The Risk taker and developer will agree on a mortality table (“Transaction Mortality Table”), i.e. the number (in %) of the 100 clients expected to die each year for the next 39 years (119 is considered to terminal). (Note that the % can be calculated to 5 decimal places even though this results in a fractional person because the probabilities are calculated on the basis of large numbers.) (Note too that this mortality table is the Risk taker's estimation of the expected outcome based upon actuarial probabilities (adjusted to reflect its margin) of people within the pool being alive i.e. probability of having to make a payment. It may or may not be the same the table that the Developer used. (Here assume that the SSA table is accurate representation of the risk. As a practical matter, it is highly unlikely that a wealthy retiree population will have the same longevity as the general population, but this example uses the SSA data for the teaching purpose herein because the data is readily available.
2. Based on these probabilities it is possible to calculate the projected number of people (of the initial pool of 100) alive each year. (“Projected Mortality”)
3. The projected number of people alive is multiplied by $30,000 (the amount that the Risk taker is committed to paying per person alive) to arrive at the Fixed Payments for all but the final payment.
4. The Final Fixed payment is equal to sum of the Year 15 payment calculated in 3 above plus an amount equal to 3.685 (the LE of the people still alive based upon the Transaction Mortality Table.)
   The variable payments that the Risk taker makes to the developer can be calculated as follows:
1. The number of people actually alive on a payment date multiplied by $30,000; plus
2. In the case of the final payment an amount equal to the product of
   a. The number of people alive on the final payment date; and
   b. $30,000; and
   c. 3.685 (the LE of those still alive on the final payment date.

With respect to the credit risk, mark to market, and escrow, at the outset of the transaction, there is no certainty as to who will pay whom (unlike a single premium annuity offered by an insurance company). Consequently both the Developer and Risk taker are taking each others credit risk i.e. the risk that the other party will not make the payments when due. To protect against credit risk the ALERTS contract will be secured by an initial escrow amount coupled with a periodic “mark to market” payment.

As to the credit risk, the marking to market ensures that neither party is exposed to credit risk in the event that actual mortality experience of the pool is different to the Projected Mortality. If the actual mortality and Projected Mortality is the same then the Variable payments and the Fixed Payments will be the same (by definition). However, if Projected Mortality is less than the actual mortality i.e. there are fewer people alive than projected, the developer will owe the Risk taker on every payment date. If the Developer fails to make these payments, the Risk taker will sustain a credit related loss. Likewise, if more people are alive than projected, the Risk taker will owe the developer payments for each person alive. If the Risk taker fails to make these payments, the Developer will sustain a credit related loss. The Mark to Market payment overcomes this risk.

Periodically, based on the agreed upon Transaction Mortality Table and the actual number of people alive, it is possible to recalculate what the fixed payments would be if the transaction was being entered into de novo at that point (“Recalculated Payment’). (If SSA has issued new mortality tables then the Mortality Table will be adjusted so that the adjusted table has the same relationship to the SSA tables as the original Mortality Table had to the original SSA tables.) The present value of the difference between contractually agreed Fixed Payments and Recalculated Payment is the “Mark to Market” value of the transaction. If the Recalculated amount is less than the Fixed Payments the Developer will make a “Mark to Market” payment to the Risk taker and vice a versa.

It is quite probable that a below expected mortality rate in one period will be offset by an above expected mortality returning the actual mortality back to the projected path. In this case any Mark to Market payment will be returned.

If at any point either party fails to make its required payments the other party shall be entitled to recover such amounts from the escrow account (established at inception of the contract) and terminate the ALERTS transaction. If that were to happen the non defaulting party would have been fully protected for any difference between actual and projected mortality as of that point in time.

At the inception of the transaction both the Risk taker and the developer will place in escrow an amount equal to equal to the sum of
1. The difference between the Fixed and Variable Payment on the next payment date;
2. The potential mark to market payment (discussed above) determined on a 95% confidence basis.

Based on this mechanism there is 97.5% probability that the escrow account will have in it sufficient funds to cover all the potential payments. A 95% confidence interval means that there is 2.5% probability of actual mortality being greater than projected and a equal probability of it being less than projected. Only one of those outcomes creates an adverse credit event.

It is possible that the developer's mortality experience will be such that it will fall outside of the 95% confidence interval. In this case the initial escrow amount will not be sufficient to cover the developer's required periodic payment and the Mark to Market payment. If the developer fails to make the required payment then the Risk taker would have to proceed against other assets of the developer for payment.

This risk is believed to be minimal because:
1. An extreme event in one transaction is unlikely to be offset by another extreme event in other ALERT transactions; so the risk taker in all probability will be exposed vis-a-vis its windfall profits;
2. If a substantially above average number of clients died the developer would have access to the upfront payments that the clients had made plus be able rent out at higher rates; not the conditions under which one would expect the developer to default on its payments.

Statistically, assuming the correct mortality table has been used there is a 99% probability that the actual LE will be within plus/minus 0.36 years of the projected LE. Assuming that the Fixed Payments are based on a Transaction Mortality Table equivalent to the SSA LE plus 1.25 years then the expected IRR is between 18-26% with 22% as the expected average outcome.

Second Hypothetical Exemplary Transaction - With Confirmation
(Numerical values in the hypothetical exemplary transaction are for
illustrative purposes and will depend on the specific transaction.)

| Fixed Payer: | ABC Corporation | |
|---|---|---|
| Variable Payer | LACC Inc. | |
| Fixed Amount: | Dec 1 2007 | $160,000 |
| | Dec 1, 2008 | $155,000 |
| | Dec 1, 2004 | $85,000 |
| | . . . | |
| Initial Pool: | Individuals identified by their date of birth and social security number number | |
| below | | |
| John doe 1 | Apr. 15, 1925 | 100-00-0001 |
| John Doe 2 | May 12, 1923 | 100-00-0002 |
| John Doe N | Jun. 2, 1928 | 100-00-10nn |

| | |
|---|---|
| Notional value: | $5,000 |
| Variable Amount: | The variable amount will consist of the sum of: |
| | A. “Variable Payment amount” calculated as the product of the number of |
| | individuals within the Initial pool still alive and the Notional Value. (based on |
| | the mortality status 30 days prior to the Fixed Amount Payment Date) |
| | B. A “Mark to Market” payment based on the attached Mark to Market |
| | Tables. |
| Net Payments: | The Fixed and Variable Payments will netted against one another. |
| Initial Escrow: | LACC Inc and ABC will each place in an escrow account an amount equal to |
| | $150,000 at the inception of the account. |
| Future Escrow: | The amount placed in escrow will be equal to the product of |
| | A. The applicable percentage from the Escrow Table; and |
| | B. The variable payment amount calculated in the Variable Payment Work |
| | Sheet. |
| Attachments: | Mark to Market Tables |
| | Escrow Table |

Example of Mark to Market Tables/Escrow

Mark to Market Tables
Period 1

| | | | | | | | |
|---|---|---|---|---|---|---|---|
| no alive | 450 | 451 | 452 | 488 | 489 | 490 | 500 |
| risk seller payment | $3,393,698 | | | | | | |
| risk taker payment | | 3223000 | | 3000000 | 3153000 | $3,313,296 | |

Period 2

| | | | | | | | | |
|---|---|---|---|---|---|---|---|---|
| no alive | | 420 | | 421 | | 485 | | 486 |
| risk seller payment | a1 | | a2 | | | | | |
| risk taker payment | | | | | b1 | | b2 | |

period n

| | | | | |
|---|---|---|---|---|
| no alive | x1 | x2 | xn-1 | xn |
| risk seller payment | an1 | an2 | | |
| risk taker payment | | | bn1 | bn2 |

Escrow Table
Period 0

| | |
|---|---|
| No Alive | 500 |
| risk seller escrow | 4000890 |
| risk taker escrow | 2706103 |

Period 1

| | | | | | | | | |
|---|---|---|---|---|---|---|---|---|
| no alive | | 420 | | 421 | | 485 | | 486 |
| risk seller escrow | d1 | | d2 | | d66 | | d67 | |
| risk taker escrow | e1 | | e1 | | e66 | | e67 | |

Period n

| | | | | |
|---|---|---|---|---|
| No Alive | x1 | x2 | xn-1 | xn |
| risk seller escrow | dn1 | dn2 | dn66 | dn67 |
| risk taker escrow | en1 | en2 | en66 | en67 |

Confirmation

One of the computers 204 of the Risk Taker (or agent acting for Risk taker) can communicate to, and one of the computers of a party to the transaction can receive, digital communication enabling all or part of the transaction. An illustrative such communication is set out below. Between risk taker 204 and Escrow Bank 200.

Hi Mary,

Attached is a copy of the standard ISDA (International Swap and Derivatives Association) master agreement that will be the basis of the risk contract. There are large amounts of this master agreement that are probably not relevant to our transaction and will be deleted. However, the important points are the definition of the events of default There would be some minor modification to incorporate the role of the Mortality Verification Agent and the Escrow accounts. Specifically, upon the occurrence of an early termination event as a result of non payment the non defaulting party will be entitled to seek reimbursement from the Escrow account. We envisage the process to work as follows:
1. Once a Risk Transfer agreement has been executed a copy of that agreement and completed escrow documents (your account opening forms, instructions etc) will be given to the escrow bank. Based on those documents Chittenden will open an escrow account for ABC Corporation and a sub account for LACC Inc.
2. Transfer the appropriate amount from LACC Inc. master escrow account into the sub accounts.
3. Annually (per risk transfer contract) you will be notified of the payments that are to be made/received. Pursuant to those contracts.—Fixed, Variable, Mark to Market and Net:
4. Based on the Escrow table (attached to the Risk Transfer Agreement) and the Variable amount in (3) above release funds from the escrow account.
5. Only in the event of an unresolved dispute would you need to calculate any amounts that would be owed. (Since, the amounts use predetermined tables and are based on the number of people alive there should be no unresolved disputes).
6. The other instance for Escrow bank's involvement (beyond making the annual payments) is in the event of a payment default. The escrow bank would have to confirm that default had in fact occurred before releasing funds from the escrow account. However, since all payments are being into and out of the escrow bank's accounts it is easy enough to establish whether a payment default has in fact occurred.

### Additional Aspects for Embodiments

The processes for the method may be stored in a carrier or computer-readable media containing a computer program for use in a computer system. According to one aspect, the computer program can includes instruction means that can be implemented to carry out or support steps of determining a target survival date for the insured, establishing the financial loss to party looking to hedge the risk, establishing a formula for determining the variable payment in the future, determining the fixed payment to be made in the future in exchange for variable payment in the future, securing each parties obligation with an initial collateral and periodically marking to market the underlying contract until its maturity. According to one aspect, the carrier is one of a CD-ROM, a floppy disk, a Zip cartridge, a magnetic media, an optical wave, and a carrier wave.

In addition to corresponding methods of making and using, as well as necessary data intermediates and products produced in various embodiments, to understand permutations, consider an apparatus for controlling a system carrying out an implementation of exchanging payments between parties related to uncertainty of risk, for example, by steps including: producing a projected outcome of having a risk event occurring; specifying a transaction in which one party exchanges a fixed payment related to the projected outcome for another party paying a variable payment related to what actually occurs, wherein the parties agree to collateralize their payments; forming a periodic mark to market to account for a difference between the projected outcome and said what actually occurs, relating the mark to market in changing a collateral amount to ensure that at least one of the parties can make its payment; and wherein at least one of the steps is carried out by a computer system.

For this or any aspect thereof, there can be a computer-readable media tangibly embodying a program of instructions executable by a computer to perform the steps of: computing a fixed payment that can be made in the future in exchange for a variable amount based on a formula that includes actual mortality performance of at least one individual and a target survival date for the at least one individual; determining a financial loss to party looking to hedge a risk that the mortality performance will differ from the target survival date; and accounting for a contract including the exchange, the accounting including securing at least one payment for each of the parties with an initial margin and periodically marking to market the contract until its maturity.

Viewed alternatively, there can be a computer-readable media tangibly embodying a program of instructions executable by a computer to control performance of a computer system carrying out the steps of: producing a projected, outcome of a risk event occurring; specifying a transaction in which each of two parties provides a collateral position; accounting, as part of the transaction, for one said party exchanging a fixed payment for another said party's variable payment, the fixed payment related to the projected outcome of the risk event occurring, the variable payment related to actual outcome of the risk event having occurred; periodically computing a mark to market measurement to determine whether one of the parties should make a change to the collateral position to ensure an ability to account for a difference between the actual outcome to the projected outcome, and if the change should be made, an amount of the change; and wherein at least one of the steps is carried out by a computer system.

From a different perspective, in understanding the robust nature of the embodiments herein, consider an electronic transmission apparatus for handling communications to implement a part of exchanging payments between parties related to uncertainty of risk, e.g., including: entering risk event data; determining, from the risk event data, a projected outcome of a risk event occurring; providing transaction data to specify a transaction in which one party exchanges a fixed payment for another party's variable payment, the fixed payment related to the projected outcome of the risk event occurring, the variable payment related to actual outcome of the risk event having occurred, wherein each party provides a collateral position to ensure an ability to make the payment; periodically computing a mark to market measurement to determine whether one of the parties should make a change to the collateral position to ensure an ability to account for a difference between the actual outcome to the projected outcome, and if the change should be made, to determine an amount of the change; and wherein at least one of the foregoing is carried out by a computer system comprised of means for sending the data set via electronic transmission, e.g., over an Internet network addressed to another computer.

Still another perspective is that of an electronic receiver apparatus for handling communications (such as the above) or to implement a part of the monitoring a transaction, including: entering risk event data; determining, from the risk event data, a projected outcome of a risk event occurring; providing transaction data to specify a transaction in which one party exchanges a fixed payment for another party's variable payment, the fixed payment related to a projected outcome of the risk event occurring, the variable payment related to actual outcome of the risk event having occurred, wherein each said party provides a collateral position to ensure an ability to make a payment; comparing the actual outcome with the project outcome at a subsequent time; if, at the subsequent time, a difference between the actual outcome and the projected outcome exceeds the collateral position of either of the parties, then signaling for a change in one of the collateral positions; and the apparatus is comprised of means for receiving the data set via electronic transmission means for communicating said data set over an Internet network.

Still another perspective is that of an electronic receiver apparatus for handling communications (such as that above) or to implement a part of a computer-aided method of exchanging payments between parties related to uncertainty of risk, the method including the steps of: producing a projected outcome of a risk event occurring; specifying a transaction in which each of two parties provides a collateral position; accounting, as part of the transaction, for one said party exchanging a fixed payment for another said party's variable payment, the fixed payment related to the projected outcome of the risk event occurring, the variable payment related to actual outcome of the risk event having occurred; periodically computing a mark to market measurement to determine whether one of the parties should make a change to the collateral position to ensure an ability to account for a difference between the actual outcome to the projected outcome, and if the change should be made, an amount of the change; and wherein at least one of the steps is carried out by a computer system, the system further comprising means for receiving the data set via electronic transmission means for communicating said data set over an Internet network.

### Variations on the Themes of Embodiments Herein

It is respectfully believed that there is a noteworthy robustness herein, at least because—depending on the embodiment of interest in a particular implementation—what has been disclosed herein allows investors to directly participate in the risk transfer process (allows risk sellers to transfer risk directly to investors/allows risk sellers to bypass traditional risk pooling, directly participating in the risk transfer process and transfer their risk directly to investors). As previously mentioned, embodiments herein have been used primarily to teach broader principles as a whole. Many particular variants are intended to be embodied within these principles.

Consider one (of many possible) perspectives: the idea that path dependent risks can be marked to market. This idea can be used to form a package—a swap, collateral positions, and mark to market as applied to all path dependent risks. The package can be tailored to relate to the particular individual risks of interest. If so desired, the package can produce a credit risk free method of transferring risk, eliminating the need for a credit worthy/rated risk taker.

The above allows for the disaggregation of the transfer for all path dependent risks into the assembling of a pool by one group of investors who then sell the pool to a group that is interested in holding the risk for a long term.

Thus, one way of articulating some embodiments (using method to teach other subject matter) is as a computer-aided method of exchanging payments between parties related to uncertainty of risk, the method including the steps of: producing a path dependent projected outcome of a risk event occurring; specifying a transaction in which each of two parties provides a collateral position; accounting, as part of the transaction, for one said party exchanging a fixed payment for another said party's variable payment, the fixed payment related to the projected outcome of the risk event occurring, the variable payment related to actual outcome of the risk event having occurred; and periodically computing a mark to market measurement to determine whether one of the parties should make a change to the collateral position to ensure an ability to account for a difference between the actual outcome to the projected outcome, and if the change should be made, to determine an amount of the change; wherein at least one of the steps is carried out by a computer system.

Risk

Risk can (representatively) include a risk that is a longevity risk or not a longevity risk. Such a risk can include an insurance risk, a longevity risk, a wind risk, weather or meteorological risk, disability risk, a litigation risk, an asset valuation risk, a liability valuation risk, a reserve for a risk, a reinsurance risk, a disaster risk, or another such risk. As regards the litigation risk, there can (representatively) be included risk of a payment of a judgment, settlement, and/or award. As regards the reserve, the reserve can (representatively) be a long term care reserve, a life insurance reserve, a mortality reserve, a life expectancy reserve, a pension reserve, a healthcare reserve, an employee benefit reserve, a charitable gift reserve, a reverse mortgage reserve, an asset valuation reserve or another such reserve. As regards the valuation, the valuation can (representatively) be a real estate valuation, a physical property valuation, an intangible asset property valuation, a valuation of a legal liability or potential liability exposure, or other such valuation. As regards the disaster, the disaster can (representatively) be a flood, earthquake, hurricane, terrorist act, catastrophic disaster or another such disaster.

Note that with the risk can come verification. So, for example, death can be established by a mortality verification agent, wind can be verified by a meter, NOAA, or local airport, an earthquake can be verified or measured by the Richter scale or Mercalli scale, terrorism act can be verified by the Department of Homeland Security or Department of Justice, fraud can be verified by an incitement, etc.

Note further that a buyer of the risk need not be required to make an upfront payment in exchange for a promise to pay in the future; need not be required to make, in exchange for a promise to pay in the future, an upfront payment sufficient to effect credit standing of a risk taker; and/or need not be required to make, in exchange for a promise to pay in the future, an upfront payment sufficient to effect credit standing of a risk taker as much as an annuity would effect the credit standing.

Collateral

Collateral can (representatively) include money, a security, a physical asset, a letter of credit, credit worthiness, a promissory note, or another such form of collateral. Note that initial collateral positions need not include collateral, e.g., where a party is believed to have sufficient credit standing (e.g., is an A rated counterparty).

Note that determining an amount of collateral can include determining a decline in value of collateral and/or an inability to make a payment when due.

Event

An event can (representatively) include a disaster, a loss, an insurance claim, a reinsurance claim, a reserve change, an asset value change, a wind event, litigation, a legal proceeding, death, fraud, a criminal act, liability, third party liability, interrupted operation, interrupted business, a civil or criminal or other kind of legal proceeding, an illegal act, restitution, asset damage, an injury to a human, an asset loss, a value loss, or other such form of event.

Insurance/Reinsurance

In any of the mentioned (context-sensitive) insurance, the insurance can (representatively) include life insurance, an annuity, property insurance, casualty insurance, health insurance, or other such form of insurance. Concomitantly, there can representatively be included reinsurance for the aforesaid insurance (including annuity). Note that “Viatical” settlements and life settlements are also included.

Transaction

Specifying a transaction can include specifying a transaction in which each of two parties provides a collateral position, specifying a transaction in which one party exchanges a fixed payment related to the projected outcome for another party paying a variable payment related to what actually occurs, wherein the parties agree to collateralize their payments providing transaction data to specify a transaction in which one party exchanges a fixed payment for another party's variable payment, the fixed payment related to the projected outcome of the risk event occurring, the variable payment related to actual outcome of the risk event having occurred, wherein each party provides a collateral position to ensure an ability to make the payment, specifying a transaction which a risk taker implements a program whereby longevity risk transfer structures are entered into on an ongoing basis to different risk sellers, wherein each said structure includes a risk seller making predetermined fixed payments to the risk taker on specified dates over a period of time in exchange for the risk taker making a variable on specified dates, the variable payments and dates defined by a formula that replicates adverse financial consequences caused to an investment or transaction as a result of an individual or pool of individuals living beyond an expected life expectancy, or otherwise consistent with the embodiments and broader principles herein. In another articulation, the specifying a transaction can include specifying an initial investment (e.g., in a pool of risk), specifying initial collateral positions, specifying the periodic computing mentioned above (e.g., of an outcome), an escrow agent or trustee for exchanging the payments, and such as the periodic computing being daily, every month, 6 months, year, etc. The specifying can include establishing an event verification agent, etc., or other such specifying of a transaction consistent herewith.

To the extent that one embodiment or another utilizes an operating agent implementation, the operating agent can do the specifying.

And with further regard to the specifying, one such as the operating agent can specify the risk event, each party in risk, a path dependent projection, a method of payment, the financial exposure to a risk, or the like, depending of course on the particular transaction desired. One such as the operating agent can also enable conveyance of a value of change, confirmation of events/change to parties, establish each parties agreement to a claim of risk (parties can also indicate their part of the agreement), establish the initial collateral position and subsequent values, formally enable conveying the initial collateral positions by Electronic Funds Transfer, etc.

With more particular regard to the nature of the transaction, the transaction can include forming a contract comprised of a risk seller and a risk taker, wherein the risk seller has acquired a longevity risk as a result of investing in a product wherein the longevity risk is present but is not the primary source of profits, and wherein the longevity risk is comprised of a risk that an individual or pool of individuals lives beyond a life expectancy thereby cause an investment of the risk seller to experience a decline in value, and wherein the risk taker agrees to hedge the decline in value. (It is thereby possible to market the contract or one party's portion thereof.)

As regards further transactions, one can package at least one of the payment portions of a transaction into an asset, and sell the asset. This enables creating asset classes (e.g., of different transaction attributes, such as risks, etc.) and portfolios comprised of one or more assets of one or more asset classes.

Communications

Transmitter and receiver discussions, such as digital communication by means of email, real time communication, or otherwise, oral or written, using devices that are mobile or hand-held devices, have been mentioned herein. Additionally, communication can include the escrow agent or the trustee confirming a payment to one or more of the parties, the initial collateral positions, Electronic Funds Transfer to an escrow agent or a trustee, etc. Electronically conveying or communicating can comprise at least one of wire instructions, mailing information, a fax number, an e-mail address, a telephone number, a cellular telephone number, or mobile contact information, and such information can be specified in the transaction. Electronically conveying or communicating can comprise at least one of contact information or a name of an individual responsible for wiring or transferring funds, and such information can be specified in the transaction. The communicating can comprise output, such as the kind of table illustrated herein, marketing information such as illustrated herein, documentation as illustrated herein, but in standard form, such as an ISDA agreement, or as custom documentation. Communication can also comprise such as a verification agent notification of change to one or more of the parties, notification of a money change from the event occurring, notification of a value of a change to level off the collateral, notification of a value of the change to parties and to a trustee, etc., one or more of the parties confirming the value of the collateral change, making the value change into an escrow agent or a trustee, or some other communication that is transmitted or received to carry out part or all of a transaction, including marketing of a potential or theoretical transaction.

Other Computing

Much computing has been discussed herein, particularly with respect to the mark to market computing based on a degree of change, and the accounting, e.g., for an event occurring, etc. To supplement that discussion, consider that the computing can, with respect to the transactions or marketing for them, extend to the pooling, and/or indexing, benchmarking, rating, valuing, monitoring, and reporting.

With regard to data and data processing to transform the input data into output data meaningful in carrying out a transaction, for example, the computing can utilize a risk event database and/or loss event database. (Note too that the data can extend beyond the confines of a transaction to such as not-risk event data and a derivative of risk event data.) Depending on the embodiment of interest in a particular implementation, data inputting can include an amount of coverage, a payment pattern, a life expectancy of at least one insured, a target survival date for at least one insured, an expected investment return (e.g., on invested assets), a cost of capital charge, a financial loss to party looking to hedge a risk, a formula that determines, defines, or prescribes a payment such as the variable payment, etc.

Further Thoughts

The pieces taught herein can be assembled into an embodiment to carry out the particular transaction of interest to the particular parties under their circumstances—this is respectfully believed to be a major point herein.

So, for example, if the parties so desire, a transaction could involve structuring the particulars of the transaction so that it (or the exchange) is not treated as insurance or reinsurance, e.g., for regulatory purposes.

And for example, if the parties so desire, a transaction could involve a computer-aided method including: specifying a transaction which a risk taker implements a program whereby longevity risk transfer structures are entered into on an ongoing basis to different risk sellers, wherein each said structure includes a risk seller making predetermined fixed payments to the risk taker on specified dates over a period of time in exchange for the risk taker making a variable on specified dates, the variable payments and dates defined by a formula that replicates adverse financial consequences caused to an investment or transaction as a result of an individual or pool of individuals living beyond an expected life expectancy; and determining an amount of collateral to ensure each of the payments.

Carrying out an example could further include entering, into one or more computers, one or more of the following: a level of risk transfer by the risk seller; financial consequences of an individual or pool of individuals living longer than their expected life expectancy.

Carrying out an example could further include determining a target survival date for the insured; establishing the financial loss to party looking to hedge the risk; establishing the formula for determining the variable payment in the future; determining the fixed payment to be made in the future in exchange for variable payment in the future; securing each parties obligation with an initial margin and periodically marking to market the underlying contract until its maturity.

Carrying out an example could further include payments defined by a formula that has an outcome that can only be known at some point in the future.

Carrying out an example could further include commitments to pay that are unrelated to whether an individual or pool survives to a particular date although the magnitude of the variable payment can be effected by the outcome.

Carrying out an example could further include accounting for a purchase of the fixed payment and the corresponding collateral position; and/or accounting for a purchase of the variable payment and the corresponding collateral position.

Carrying out an example could further include more than one computer cooperating in a system, e.g., a private investor computer accounting for acquisition of one of the payments, a hedge fund computer generating a valuation of hedge fund investments including one of the payments, etc.

Viewed from a different perspective, the pieces can be assembled otherwise to carry out the particular desires of the parties involved. So, for example, if the parties so desire, a transaction could involve a computer-aided method including: computing a fixed payment that can be made in the future in exchange for a variable amount based on a formula that includes actual mortality performance of at least one individual and a target survival date for the at least one individual; determining a financial loss to party looking to hedge a risk that the mortality performance will differ from the target survival date; and accounting for a contract including the exchange, the accounting including securing at least one payment for each of the parties with an initial margin and periodically marking to market the contract until its maturity.

Carrying out an example could further include computing includes estimating a life expectancy for an insured and/ or identifying a target survival date based on the determined life expectancy. Depending on the parties preference, the marking to market can include a re-estimating the life expectancy based on actual performance of a pool, and/or a re-estimating the life expectancy based on a change in life expectancy unrelated to a pool. Also depending on the parties preference, the determining the financial loss can comprise at least one of i) assessing an increased interest cost, ii) assessing a decline collateral value and iii) assessing an inability to repay debt, based on the insured living to the target survival date; and further including determining a survival benefit based on the result of the at least one assessment. Yet further depending on the parties preference, the initial margin payment can be calculated based on estimating within at least 1, better 2, and preferably 3 or more standard deviations of a magnitude of the marking to market.

Carrying out an example could further include calculating the fixed payment to be made in the future based on a probability that a pool can survive to certain age adjusted to reflected excise taxes and at least one other cost, and/or accounting for the initial margin held on behalf of the parties to the contract in an investment.

Viewed from still a different perspective, the pieces can be assembled otherwise to carry out the particular desires of the parties involved, such as a method for using a computer in determining a target survival date for the insured; establishing the financial loss to party looking to hedge the risk; establishing the formula for determining the variable payment in the future; determine the fixed payment to be made in the future in exchange for variable payment in the future; and securing each parties obligation with an initial margin and periodically marking to market the underlying contract until its maturity.

Viewed from yet still a different perspective, the pieces can be assembled otherwise to carry out the particular desires of the parties involved, such as a computer-aided method for estimating the financial consequences of a longer than expected life of the pool, the method comprising: determining a life expectancy of an insured; determining at least one fixed payment that can be exchanged for at least one variable payment, each of the payments formulaically related to the life expectancy and actual experience; and determining at least one amount corresponding to each of the at least one fixed payment and the at least one variable payment, each amount related to ability to make one of the payments, the ability determined by assessing at least one of an increased interest cost, a decline collateral value, and an inability to repay a debt.

Carrying out an example could further include: creating a contract for a risk transfer, wherein the risk is formulaically related to the life expectancy and the actual experience; and generating documentation for the risk transfer including insertion of a computed number into the documentation. {what number would be computed}

Viewed from an additional perspective, the pieces can be assembled otherwise to carry out the particular desires of the parties involved, such as a computer-aided method supporting a transfer of financial consequences for an individual or pool of individuals not living to their expected life expectancy, the method comprising: determining a target survival date for an insured; determining a fixed payment;

determining, by a formula that includes the target survival date, a variable payment to be made in exchange for receiving the fixed payment, determining standard deviations in a calculation of at least one margin requirement for making the exchange; marking to market to determine a collateral requirement for making at least one future payment.

Note that the foregoing has referenced “method” as an expedient to refer to apparatus (e.g., programmed computer system), method of making such an apparatus as well as a method of using such an apparatus, contemplating too all necessary intermediates and related products. So for example, an embodiment can be viewed as a computer-readable medium for use in a computer system having a display and including a user defined database management system or spread sheet which stores data, the computer readable medium being encoded with a computer program for managing a plurality of data that defines attributes of an insured, the data including at least one of an insured's age at issue, sex, occupation, population mortality experience, insurance and annuity buyers mortality experience, expected rates of futures mortality improvements, family medical history, and/or the insured's own medical history, the computer-readable medium comprising: instructions for causing the computer system to determine a target survival date for the insured, a fixed payment, and a variable payment to exchange for the fixed payment, and to recalculating life expectancy and marking to market to determine whether a change in collateral position is necessary. The computer-readable medium, wherein the medium is one of a CD-ROM, a floppy disk, a Zip cartridge, a magnetic media, and an optical or other wave used as a storage media.

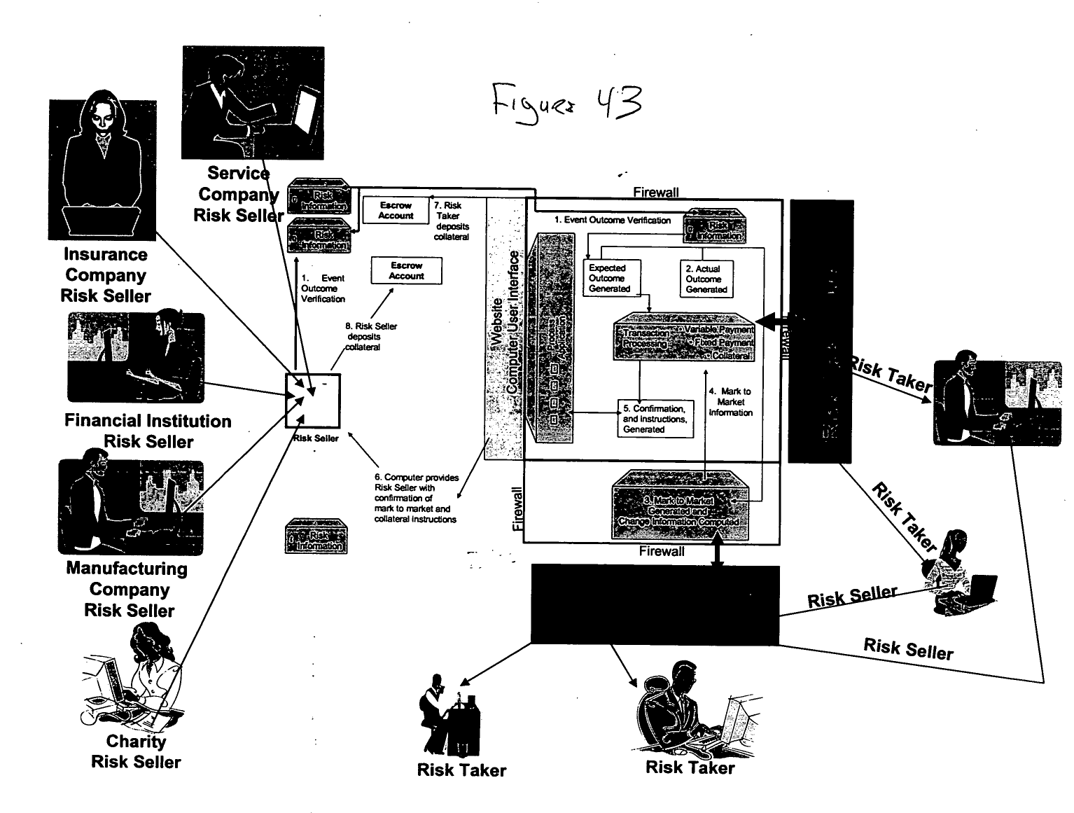

As illustrated in FIG. 44 illustrates an embodiment for capabilities, at a high level the capabilities associated with such a method can be viewed as three over lapping areas of data, analytics, and productization. Although these areas and associated activities are not necessarily sequentially related and are typically more iterative, the three areas can be thought of as a knowledge-based assembly-line of sorts. And a sufficient level of capabilities across areas is required to execute successful risk transfer transactions.

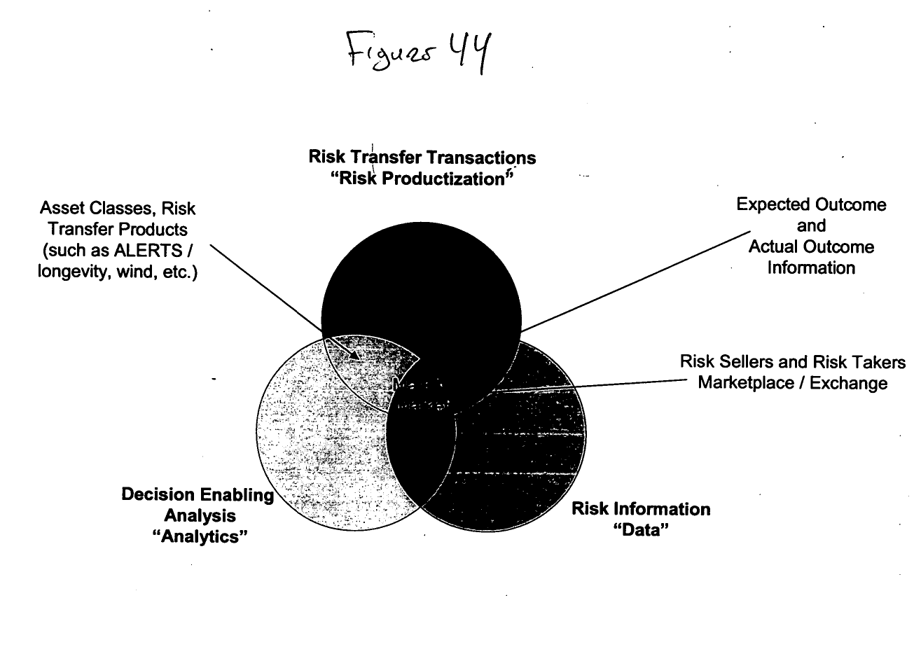

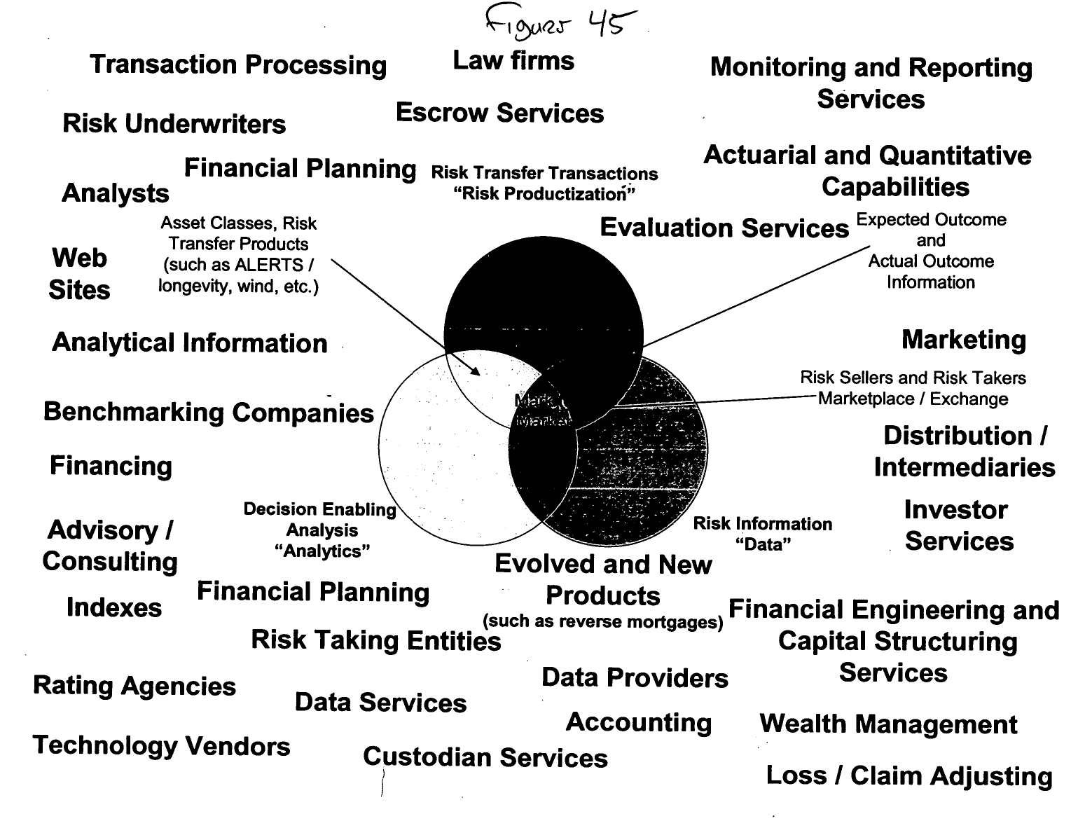

Capabilities that are required to successfully transact a single transaction are substantially similar as those required to build and sustain multiple transactions and subsequently a market. Accordingly, as illustrated in FIG. 45, other areas are enabled for additional commerce related hereto, such as consulting and advisory services, monitoring, and reporting services, etc.

In sum, appreciation is requested for the robust range of possibilities flowing from the core teaching herein. More broadly, however, the terms and expressions which have been employed herein are used as terms of teaching and not of limitation, and there is no intention, in the use of such terms and expressions, of excluding equivalents of the features shown and described, or portions thereof, it being recognized that various modifications are possible within the scope of the embodiments contemplated and suggested herein. Further, various embodiments are as described and suggested herein. Although the disclosure herein has been described with reference to specific embodiments, the disclosures are intended to be illustrative and are not intended to be limiting. Various modifications and applications may occur to those skilled in the art without departing from the true spirit and scope defined in the appended claims.

Thus, although only a few exemplary embodiments have been described in detail above, those skilled in the art will readily appreciate that many modifications are possible in the exemplary embodiments without materially departing from the novel teachings and advantages herein. Accordingly, all such modifications are intended to be included within the scope defined by claims. In the claims, means-plus-function claims are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment fastening wooden parts, a nail and a screw may be equivalent structures.

We claim:

1. A computer-aided method of exchanging payments between parties related to uncertainty of risk, the method including the steps of:
producing a path dependent projected outcome of a risk event occurring;
specifying a transaction in which each of two parties provides a collateral position;
accounting, as part of the transaction, for one said party exchanging a fixed payment for another said party's variable payment, the fixed payment related to the projected outcome of the risk event occurring, the variable payment related to actual outcome of the risk event having occurred;
periodically computing a mark to market measurement to determine whether one of the parties should make a change to the collateral position to ensure an ability to account for a difference between the actual outcome to the projected outcome, and if the change should be made, to determine an amount of the change; and
wherein at least one of the steps is carried out by a computer system.

2. The method of claim 1, wherein the risk is an insurance risk.

3. The method of claim 1, wherein the risk is longevity risk.

4. The method of claim 1, wherein the risk is wind risk.

5. The method of claim 1, wherein the risk is a reinsurance risk.

6. The method of claim 1, wherein the risk is a reinsurance risk for life insurance.

7. The method of claim 1, wherein the risk is third party liability.

8. The method of claim 1, wherein the risk is interrupted operation.

9. The method of claim 1, wherein the risk is interrupted business.

10. The method of claim 2, wherein the insurance is life insurance.

11. The method of claim 2, wherein the insurance is an annuity.

12. The method of claim 2, wherein the insurance is property insurance.

13. The method of claim 2, wherein the insurance is casualty insurance.

14. The method of claim 2, wherein the insurance is health insurance.

15. A computer-aided method of exchanging payments between parties related to uncertainty of risk, the method including the steps of:
producing a projected outcome of a risk event occurring;
specifying a transaction in which each of two parties provides a collateral position;
accounting, as part of the transaction, for one said party exchanging a fixed payment for another said party's variable payment, the fixed payment related to the projected outcome of the risk event occurring, the variable payment related to actual outcome of the risk event having occurred;
periodically computing a mark to market measurement to determine whether one of the parties should make a change to the collateral position to ensure an ability to account for a difference between the actual outcome to the projected outcome, and if the change should be made, an amount of the change; and
wherein at least one of the steps is carried out by a computer system.

16. A computer-aided method of exchanging payments between parties related to uncertainty of risk, the method including the steps of:
producing a projected outcome of having a risk event occurring;
specifying a transaction in which one party exchanges a fixed payment related to the projected outcome for another party paying a variable payment related to what actually occurs, wherein the parties agree to collateralize their payments;
forming a periodic mark to market to account for a difference between the projected outcome and said what actually occurs, relating the mark to market in changing a collateral amount to ensure that at least one of the parties can make its payment; and
wherein at least one of the steps is carried out by a computer system.

17. A computer-aided method of exchanging payments between parties related to uncertainty of risk, the method including the steps of:
entering risk event data;
determining, from the risk event data, a projected outcome of a risk event occurring,
providing transaction data to specify a transaction in which one party exchanges a fixed payment for another party's variable payment, the fixed payment related to the projected outcome of the risk event occurring, the variable payment related to actual outcome of the risk event having occurred, wherein each party provides a collateral position to ensure an ability to make the payment;
periodically computing a mark to market measurement to determine whether one of the parties should make a change to the collateral position to ensure an ability to account for a difference between the actual outcome to the projected outcome, and if the change should be made, to determine an amount of the change; and
wherein at least one of the steps is carried out by a computer system.

18. A computer-aided method of monitoring a transaction, the method including the steps of:
entering risk event data;
determining, from the risk event data, a projected outcome of a risk event occurring,
providing transaction data to specify a transaction in which one party exchanges a fixed payment for another party's variable payment, the fixed payment related to a projected outcome of the risk event occurring, the variable payment related to actual outcome of the risk event having occurred, wherein each said party provides a collateral position to ensure an ability to make a payment;
comparing the actual outcome with the project outcome at a subsequent time;
if, at the subsequent time, a difference between the actual outcome and the projected outcome exceeds the collateral position of either of the parties, then signaling for a change in one of the collateral positions; and
wherein at least one of the steps is carried out by a computer system.

19. A computer-aided method of exchanging payments between parties related to uncertainty of risk, the method including the steps of:
producing a projected outcome of a risk event occurring;
specifying a transaction in which each of two parties provides a collateral position;
accounting, as part of the transaction, for one said party exchanging a fixed payment for another said party's variable payment, the fixed payment related to the projected outcome of the risk event occurring, the variable payment related to actual outcome of the risk event having occurred;
periodically computing a mark to market measurement to determine whether one of the parties should make a change to the collateral position to ensure an ability to account for a difference between the actual outcome to the projected outcome, and if the change should be made, an amount of the change; and
wherein at least one of the steps is carried out by a computer system.

20. A computer-aided method for accounting, the method including the steps of:
computing a fixed payment that can be made in the future in exchange for a variable amount based on a formula that includes actual mortality performance of at least one individual and a target survival date for the at least one individual;
determining a financial loss to party looking to hedge a risk that the mortality performance will differ from the target survival date; and
accounting for a contract including the exchange, the accounting including securing at least one payment for each of the parties with an initial margin and periodically marking to market the contract until its maturity.

21. The method according to claim 20, wherein the exchange is not insurance or reinsurance.

22. A computer system comprising:
a computer system comprising an input device, for changing input information into input electrical signals, and output device for changing output signals into human-readable output, and at least one processor programmed to control the system to carry out the operations of:
determining a target survival date for the insured;
establishing a financial loss to a party to a contract looking to hedge the risk, the contract including another party;
establishing a formula for determining a variable payment in the future;
determining, for the parties, a fixed payment to be made in exchange for the variable payment;
recording each of the parties obligations with an initial margin; and
periodically marking to market the underlying contract until its maturity.

23. A computer-aided method for estimating the financial consequences of a longer than expected life of the pool, the method comprising the steps of:
determining a life expectancy of an insured;
determining at least one fixed payment that can be exchanged for at least one variable payment, each of the payments formulaically related to the life expectancy and actual experience;
determining at least one amount corresponding to each of the at least one fixed payment and the at least one variable payment, each amount related to ability to make one of the payments, the ability determined by assessing at least one of an increased interest cost, a decline collateral value, and an inability to repay a debt.

24. The method in accordance with claim 23, further including the steps of: creating a contract for a risk transfer, wherein the risk is formulaically related to the life expectancy and the actual experience; and
generating documentation for the risk transfer including insertion of a computed number into the documentation.

25. A computer-aided method supporting a transfer of financial consequences for an individual or pool of individuals not living to their expected life expectancy, the method comprising:
determining a target survival date for an insured;
determining a fixed payment;
determining, by a formula that includes the target survival date, a variable payment to be made in exchange for receiving the fixed payment,
determining standard deviations in a calculation of at least one margin requirement for making the exchange; and
marking to market to determine a collateral requirement for making at least one future payment.

26. A computer-readable medium for use in a computer system having a display and including a database management system or spread sheet which stores data, said computer readable medium being encoded with a computer program for managing a plurality of data that defines attributes of an insured, the data including at least one of an insured's age at issue, sex, occupation, population mortality experience, insurance and annuity buyers mortality experience, expected rates of futures mortality improvements, family medical history, and/or the insured's own medical history, the computer-readable medium comprising: instructions for causing the computer system to determine a target survival date for the insured, a fixed payment, and a variable payment to exchange for the fixed payment, and to recalculating life expectancy and marking to market to determine whether a change in collateral position is necessary.

27. The computer-readable medium according to claim 26, wherein the medium is one of a CD-ROM, a floppy disk, a Zip cartridge, a magnetic media, and an optical wave.
